(19) United States
(12) Patent Application Publication
(10) Pub. No.: US 2002/0080179 A1
(43) Pub. Date: Jun. 27, 2002

(54) Data transfer method and data transfer device

(76) Inventors: Toshihiko Okabe, Yokohama (JP); Chisato Okabe, Yokohama (JP)

Correspondence Address: Toshihiko Okabe, 2-9-5-803, Tsunashima-nishi, Kouhoku, Yokohama, Kanagawa, JP

(21) Appl. No.: 09/749,084

(22) Filed: Dec. 25, 2000

(51) Int. Cl. G06F 3/00

(52) U.S. Cl. 345/769

(57) ABSTRACT

Problem to be Solved: A first object is to simplify transferring operation after the specification of a range by an input device to a clipboard or various application programs and so forth. And a second object is to allow access to related resources from data of a specified range even for those areas for which there is no link on the page in the case the transfer destination of the above data is a search server, and improve its operability.

Solution:

Whether coordinates obtained by the switching operation of the input device (S2) are included within a range specified by the range specifying operation of the input device which was executed prior to the switching operation or not is decided (S3). At the time of judging that the coordinates are included within the specified range (S3: YES), the data in the specified range are transferred to a transfer destination (S4). Thus the operability of the device can be improved.

### BACKGROUND OF THE INVENTION AND RELATED ART STATEMENT

This invention relates to a data transfer method and data transfer device that are able to improve operability when transferring data of a specified range to a clipboard, to an editor or other application program, or to an Internet search page using a mouse, touch panel, keyboard or other input device with respect to documents, images or sound (shown by transforming into a moving waveform graph) and so forth that are arbitrarily selected and displayed by a user. Furthermore, the present application is based on Japanese Patent Application No. 10-320055 (Japanese Unexamined Patent Publication No. 2000-122774), Japanese Patent Application No. 10-377205 (Japanese Unexamined Patent Publication No. 2000-200277) and Japanese Patent Application No. 11-377485 pertaining to inventions of the present inventor, and the present application quotes the contents of those applications.

In the operating system and application programs of personal computers equipped with the so-called Windows system, various types of operations can be performed using a mouse or other pointing device. For example, operations can be performed such as dragging a line of text after selecting with a mouse, or clicking on a button icon or link with a mouse button.

For example, when considering the operation of copying an arbitrary line of text from a WWW (World Wide Web) browser to a document editor, in the case of the procedure used in the past, the line of text is first selected using a mouse and so forth on the WWW browser (range specification area 80), and a copy command is executed from “Edit” of pull-down menu 8. Subsequently, with the focus on the editor, after placing the mouse cursor at the desired location, the paste command is executed from “Edit” of the pull-down menu of the editor (see FIG. 55). In addition, when the mouse is provided with two switches on the right and left sides and it is possible to display a context menu with the right button (second switch), this procedure may also be performed by selecting a line of text using the left mouse button (first switch) (range specification area 80), displaying context menu 81 with the right mouse button (second switch) and executing the copy and paste commands from context menu 81 using the left mouse button (first switch) (see FIG. 56).

Even though the above procedure is redundant, since it is a procedure that persons handling computers must become accustomed to, it has been followed without question. Although an operation by which a line of text is selected is necessary, it is desirable that the following copy operation be simpler. Since this is a basic operation, having to go through several different procedures, having to change fingers several times to press buttons, or having to move the mouse considerably to a pull-down menu prevent the obtaining of smooth operability. Even with respect to an operation consisting of transferring a selected line of text to a text processing program, it is desirable that the transfer operation after selecting the line of text be as simple as possible. This applies similarly to images and waveform graphs that provide visual representations of sound.

On the other hand, although WWW browsers are able to display hypertext on a WWW (World Wide Web), by performing the operation of clicking the link area describing a URL (Uniform Resource Locator) embedded in the hyper text with a mouse button, it is possible to access documents, still images, animated images, sound, applications and so forth at the link destination. There are also formats for documents that also make it possible to display text other than hyper text by the addition of so-called plug-in software.

However, the above leads to a link location provided according to the page producer, and specification of a link destination has the nature of being under the complete control of the page producer. Namely, even in the case of a word appearing on a page for which a user would like to know more about, if a link is not provided for that word, the user is not able to proceed any further, meaning that it is not possible to access other resources from areas other than link locations. Such a page is confined to the intentions of the page producer, and there is no freedom whatsoever for persons viewing this page. The next link that is reached is only the link of a reference location. Following the advocacy of hyper text in 1965, hyper text has developed only in the direction for such document referencing. If it was possible to obtain a new link that makes it easy to link from an arbitrary location on a page, users would be willing to disable the compulsory links provided by page producers. Furthermore, in the case of text editors, it is not possible to directly reach another resource from any area of a displayed document since they are inherently not links.

Therefore, in order to reach resources other than those at the location of this link, it is necessary, for example, to use a search site on the Internet or search a dictionary and so forth on CD-ROM. In the case of the former, after connecting to the search site, the user is required to perform an operation consisting of writing in some form of key word in a character input box and then pressing a search execute button. Moreover, when searching, a page containing this character input box must be displayed. In addition, there is also software that assists in performing this search operation. After writing in a key word in the character input box or specifying the range of a line of text from a page on an editor or browser with a mouse, that data is transferred by copying and pasting and so forth to the character input box. In addition, in the case of the latter, an operation must be performed consisting of first starting up the dictionary software, writing in a key word into the character input box and pressing a search execute button.

As an example of a data transfer method for which service is already being provided with WWW browsers, a two-button mouse is used to transfer a key word to a search server, a key word is selected by specifying the range with the left button, the right button is clicked on the key words to display a context menu after which the search command that appears in this menu is executed. This operation has the same operability as an operation in which copy and paste commands are executed for text data of a specified range. However, the above procedure is redundant as previously mentioned. Although the operation for selecting a key word is necessary, it is desirable that the operation method through execution of the following search command be more easily understood, simpler and more convenient to use. For example, if operability can be obtained that is similar to clicking the link area of hyper text, it would be useful in terms of standardizing operability as well.

Furthermore, although an unexamined patent publication exists comprising an input method in the telecommunications processing device of Japanese Patent Application No. 9-325875, this performs communication with a Character User Interface (CUI) by directly connecting a host computer serving as a communication center with a user terminal, and relates to an input method on a so-called personal computer communication system. This publication relates to an input method for guiding to an information screen prepared in advance by sequentially following a hierarchical structured menu transmitted by a host computer. The menu is predetermined, and is already outdated from the viewpoint of a flexible communication method like the current World Wide Web (WWW) that allows users to arbitrarily select and display files, making it difficult to consider this to be a user-friendly interface. An example of a similar system is the menu system of the touch panels in Personal Digital Assistants (PDA) and so forth. The various items of the menu are actually switches that are statically fixed.

Therefore, a first object of the present invention is to improve operability when transferring data such as a part of lines of text, images, progressive graphs or waveform graphs for which the range has been arbitrarily specified by a user from text, still images, progressive graphs of animated images, waveform graphs providing a visual representation of sound arbitrarily selected and displayed by a user to a clipboard or various application programs and so forth.

In addition, a second object of the present invention is to allow access to related resources from data of a specified range even for those areas for which there is no link on the page in the case the transfer destination of the above data is a data search server, and improve its operability.

### SUMMARY OF THE INVENTION

The data transfer method and data transfer device of the present invention judges whether or not coordinates when a switching operation has been performed by an input device following a range specification operation of an arbitrary range by an input device are within said specified range for an operation target such as a text file, WWW page or file desired to be displayed on a screen by a user arbitrarily selected by a user, and transfers data within a specified range to a transfer destination in the case said coordinates are judged to be within said specified range. This operation target is not fixed and an operation target is displayed that is selected by the free will of the user. The present invention is characterized by being able to perform a range specification operation selected by the free will of a user for this operation target. Then, after specifying the range, data within a specified range is transferred to a transfer destination simply by operating a switch in that specified range. Since the specified range can be expressed with a plurality of coordinates, by investigating the positional relationship between each coordinate and the coordinate when a clicking operation was performed, it can be determined whether or not coordinates are within that range. Thus, a user is able to arbitrarily select an operation target, and after specifying an arbitrary range for that operation target, data within that specified range can be transferred to a transfer destination simply by performing a switching operation in that specified range. This operation can be intuitively understood by anyone, and is easy, smooth and convenient. It also enables operating time to be reduced dramatically. There have been no other devices in the past that have realized such good operability for target operations arbitrarily selected by users.

In addition, in the case the transfer destination is a search server, related resources can be easily accessed by employing an operation similar to that described above even for an area for which there is no link on a page. Favorable operability like that described above is also realized in this case as well. Although it was necessary in the past to display a certain page containing a search form each time whenever a search was made, with the present invention, searches can be performed with any page displayed and even on text files. The range specification operation is equivalent to the user himself imparting a link to an operation target, and the switching operation by an input device thereon realizes operability similar to clicking on the location of a hyper text link.

Furthermore, examples of input devices include a mouse, track ball, touch panel, pen tablet, light pen, eye pointer, digitizer or other pointing device, as well as the arrow keys of a keyboard. Different from an input device, a switch refers to, for example, a button in the case of a mouse, the enter key or another set key in the case of a keyboard, or a remote control button or switch mounted on the device in the case of a home appliance that can be connected to the Internet. In addition, switching operation refers to, for example, a clicking operation in the case of a mouse, and this operation of clicking refers to pressing and releasing a button provided on a mouse. In the case of a touch panel, the panel is operated by touching the surface with a finger or pen. There is no difference in switching on and off even in the case of a touch panel. In addition, the switching operation may refer to a single click, double click or triple click in the case of a mouse, and which of these is used depends on the design. Furthermore, the shape of a cursor may be displayed after changing to the shape of an arrow or other pointer when the cursor is within the above specified range.

### BRIEF DESCRIPTION OF THE DRAWINGS

The invention disclosed herein will be understood better with reference to the following drawings of which:

FIG. 1 is a block drawing of a data transfer device of a first embodiment.

FIG. 2 is a drawing of a display in use of this data transfer device.

FIG. 3 is a hardware block drawing in the case of realizing the device of FIG. 1 using CPU 2.

FIG. 4 is a block drawing representing the processing of a mouse event.

FIG. 5 is a schematic drawing showing a range specification region.

FIG. 6 is an explanatory drawing of the state of use showing the actual state of being about to perform a left click after finishing range specification on a WWW page.

FIG. 7 is an explanatory drawing of the state of use showing the actual state of a specified range copied to an HTML editor.

FIG. 8 is a drawing showing line of text 50 and mouse pointer 5. FIG. 9 is a drawing showing line of text 50 and mouse pointer 5.

FIG. 10 is a flow chart of mouse program 30.

FIG. 11 is a drawing showing a range specification state of a still image.

FIG. 12 is a drawing showing a range specification state of a sound represented with a graph.

FIG. 13 is a schematic drawing showing a range specification region.

FIG. 14 is a drawing showing line of text 50 and mouse pointer 5.

FIG. 15 is a drawing showing line of text 50 and mouse pointer 5.

FIG. 16 is a drawing showing line of text 53 and mouse pointer 5.

FIG. 17 is a flow chart of a mouse program for realizing range specification.

FIG. 18 is a drawing showing a sectional region.

FIG. 19 is a drawing showing line of text 53, extended range 54 and mouse pointer 5.

FIG. 20 is a flow chart of a mouse program for realizing range specification.

FIG. 21 is a drawing showing the operating state of search switch 7 set as a specified range.

FIG. 22 is a block drawing of a data transfer device of a second embodiment.

FIG. 23 is a drawing showing a screen display of WWW browser 4 displayed after receiving search results.

FIG. 24 is a hardware block drawing in the case of realizing the device of FIG. 22 using CPU 2.

FIG. 25 is a drawing showing the flow of data via the Internet.

FIG. 26 is a flow chart of a mouse program for realizing transfer of data within a specified range.

FIG. 27 is a flow chart of a program of WWW browser 4 that displays search results.

FIG. 28 is an explanatory drawing of the state of use showing the actual state of being about to perform a left click after finishing range specification on a WWW page.

FIG. 29 is an explanatory drawing of the state of use showing the actual state of search results received and displayed with WWW browser 4.

FIG. 30 is a drawing showing CD-ROM 23.

FIG. 31 is a drawing showing a processing block for receiving transfer destination data via the Internet.

FIG. 32 is a drawing showing hard disk 21 that records transfer destination setting program 300.

FIG. 33 is a drawing showing dialogue box 6 for performing setting of transfer destination.

FIG. 34 is an explanatory drawing of the state of use showing the actual state of performing transfer destination (search destination) selection.

FIG. 35 is a drawing showing a manner of range specification in which the left button (first button) of a mouse is used continuously.

FIG. 36 is a drawing showing an operation method in which a menu is displayed in the case a mouseClick event with the left button occurs following the range specification operation of FIG. 35.

FIG. 37 is a flow chart of a mouse program in which a transfer destination is made to be displayed in the form of a menu.

FIG. 38 is a flow chart of a mouse program in the case of selecting a default transfer destination or a transfer destination according to a pop-up menu.

FIG. 39 is a drawing showing a screen display of WWW browser 4 having a link disable switch 49.

FIG. 40 is a flow chart of a processing program that disables a link.

FIG. 41 is a drawing showing pop-up menu 64 provided with link-disabling menu 65.

FIG. 42 is a drawing showing the flow of characteristic information data from the Internet to a processing block.

FIG. 43 is a drawing showing a menu that presents received characteristic information.

FIG. 44 is a drawing showing a format of transmitted user-characteristic information.

FIG. 45 is a flow chart of a mouse program for realizing translated transfer of data within a specified range.

FIG. 46 is a flow chart of a mouse program that transfers data within a specified range in the case a switching operation corresponding to an onClick by the enter key on a keyboard has occurred following a range specification operation.

FIG. 47 is a block drawing of the periphery of input/output control unit 33 for audio input.

FIG. 48 is a drawing showing hard disk 21 installed with voice recognition program 305.

FIG. 49 is a drawing showing focused agreement range 56.

FIG. 50 is a flow chart of a touch panel program that transfers to a transfer destination after specifying a range by voice recognition.

FIG. 51 is a flow chart of a program that causes the focus directed at a link display area to jump between link display areas by pressing a direction key.

FIG. 52 is a reference drawing showing CD-ROM 85.

FIG. 53 is a reference drawing showing CD-ROM 85.

FIG. 54 is a flow chart of an installation program for separately installing a search destination.

FIG. 55 is a drawing displaying pull-down menu 8 of the related art.

FIG. 56 is a drawing displaying context menu 81 of the related art.

### DETAILED DESCRIPTION OF THE PREFERRED EMBODIMENTS

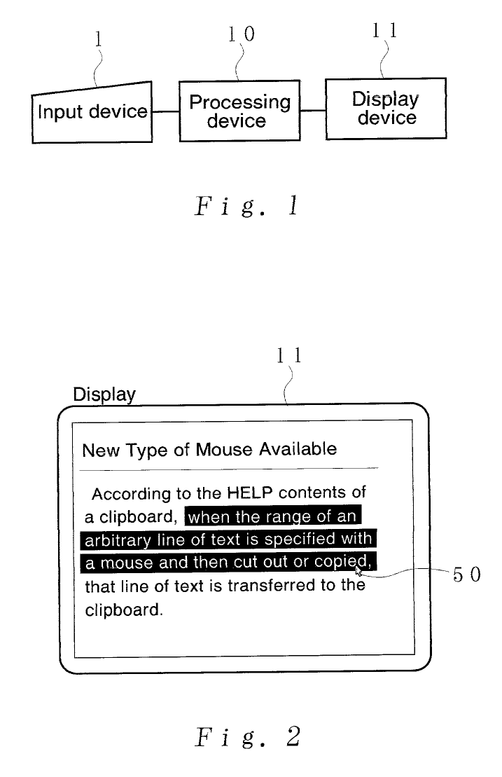

FIG. 1 shows the entire constitution of a data transfer device as claimed in a first embodiment. Input device 1 is a pointing device for enabling an operator to perform range specification and clicking operations. Display device 11 is for displaying documents that are the operation targets of input device 1 as well as the cursor of input device 1. Although an explanation is provided of the case of performing global memory copying of data within a specified range in this embodiment, the present invention is not limited to this, but rather the present invention can be similarly applied to the case of transferring this data to another device or program that requires this data. Examples of transfer destinations include a document editing program such as an editor, the transmission screen of an electronic mail client and an agent program that processes jobs in place of a user.

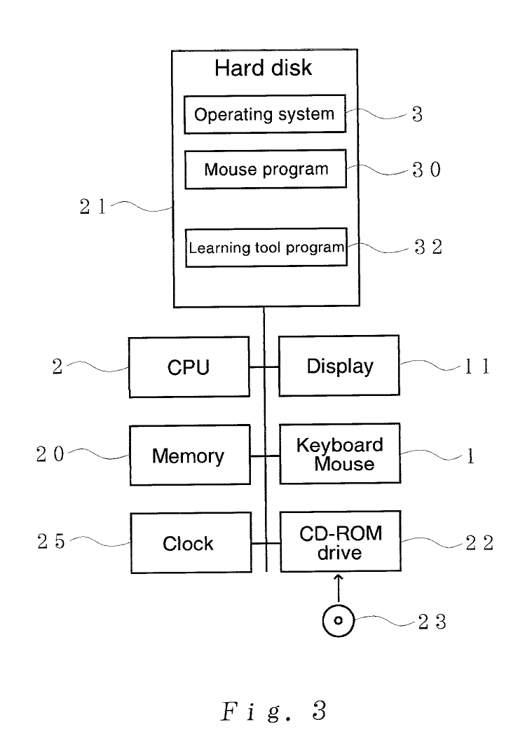

When an operator first specifies the range of a sentence displayed on display device 11 with the cursor of input device 1 by operating said input device 1, processing device 10 highlights and displays a line of text of this range specified area. In the case range specification is not performed successfully, the operator can redo range specification. Next, since the cursor ought to be at the final position of the specified range, when the operator moves this cursor within the specified range and performs a clicking operation within that specified range, processing device 10 copies the data in the specified range to global memory. The above-mentioned highlighted display is then canceled. This series of operations are truly simple, consist only of a range specification operation and a clicking operation, and the operator is required to move the mouse only slightly between these two operations. Furthermore, reference symbol 50 in FIG. 2 represents a range specified area. Although this range specified area is highlighted here, this processing is not limited to highlighting, but rather only requires that this range specified area be made to stand out from other areas by, for example, changing the character color or underlining.

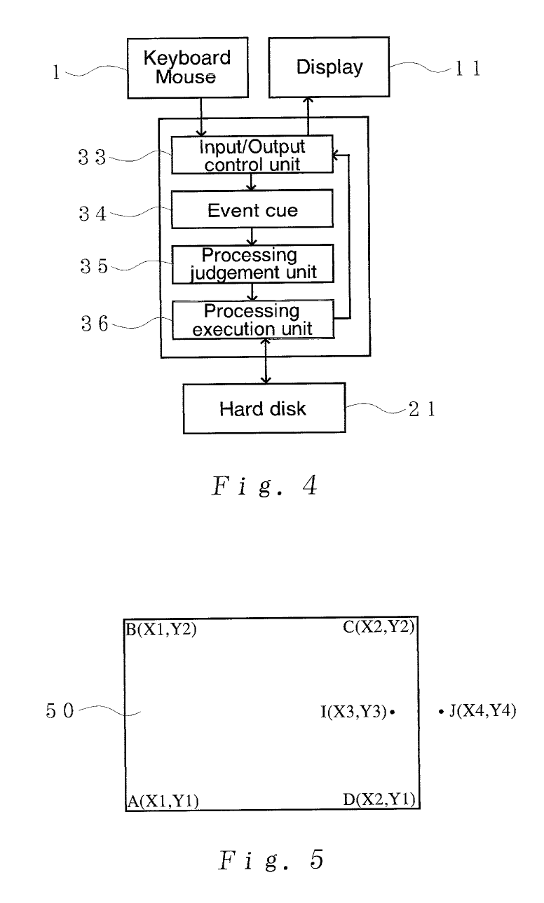

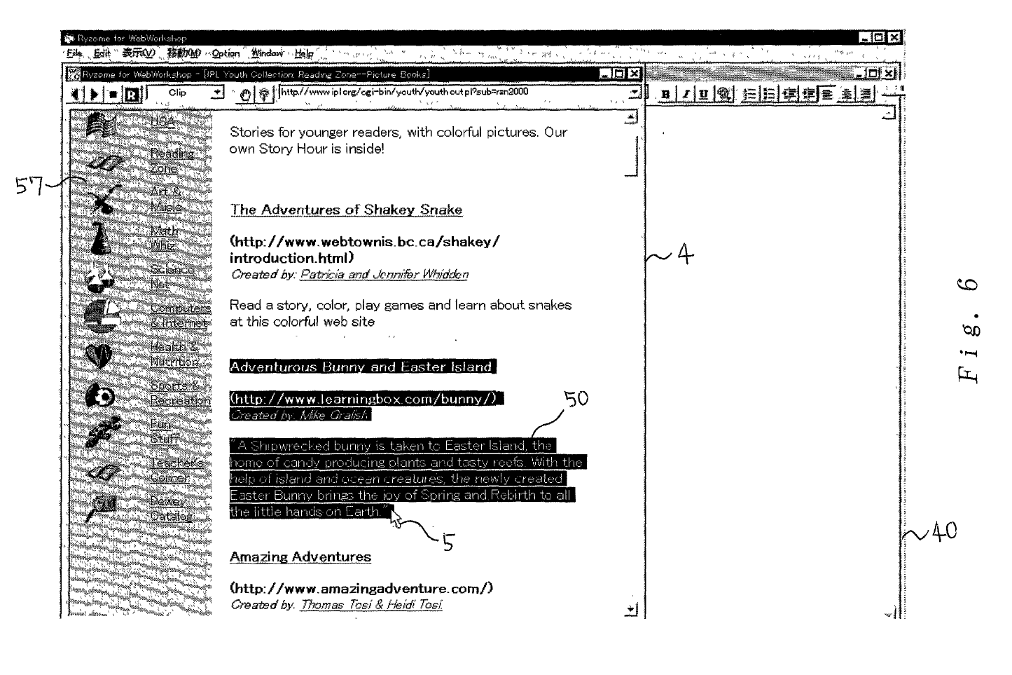

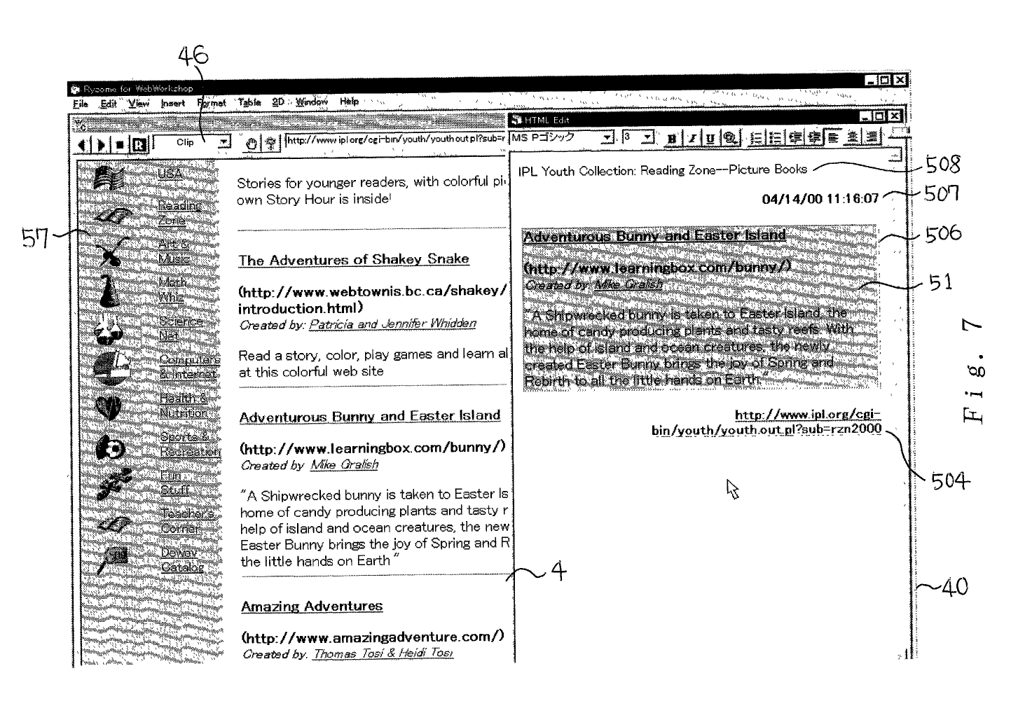

Processing device 10 of FIG. 1 can also be realized using CPU 2. The next embodiment is an application software that copies data for which the range is specified on WWW browser 4 to HTML editor 40 using CPU 2, and examples of actual screen displays are shown in FIGS. 6 and 7. In addition, each processing unit realized with CPU 2 of FIG. 3 is shown in FIG. 4. Furthermore, processing device 10 can also be composed by hardware logic without using a CPU.

Memory 20, a storage device in the form of hard disk 21, an input device in the form of mouse 1, a display device in the form of display 11 and CD-ROM drive 22 are connected to CPU 2. Operating system OS3, a data transfer program in the form of mouse program 30 and learning tool program 32, which contains a window frame that contains a window that displays WWW browser 4 and a window that displays HTML editor 40, are stored in hard disk 21. This mouse program 30 and learning tool program 32 are installed from CD-ROM 23 via CD-ROM drive 22. Furthermore, mouse 1 here is a two-button mouse.

FIG. 5 shows a range specification region. FIG. 6 shows WWW browser 4 and HTML editor 40 displayed on display 11. In FIG. 6, the actual state of being about to click using the left button following completion of range specification on WWW page 57. FIG. 7 shows the actual state of range specified area 50 being copied to HTML editor 40.

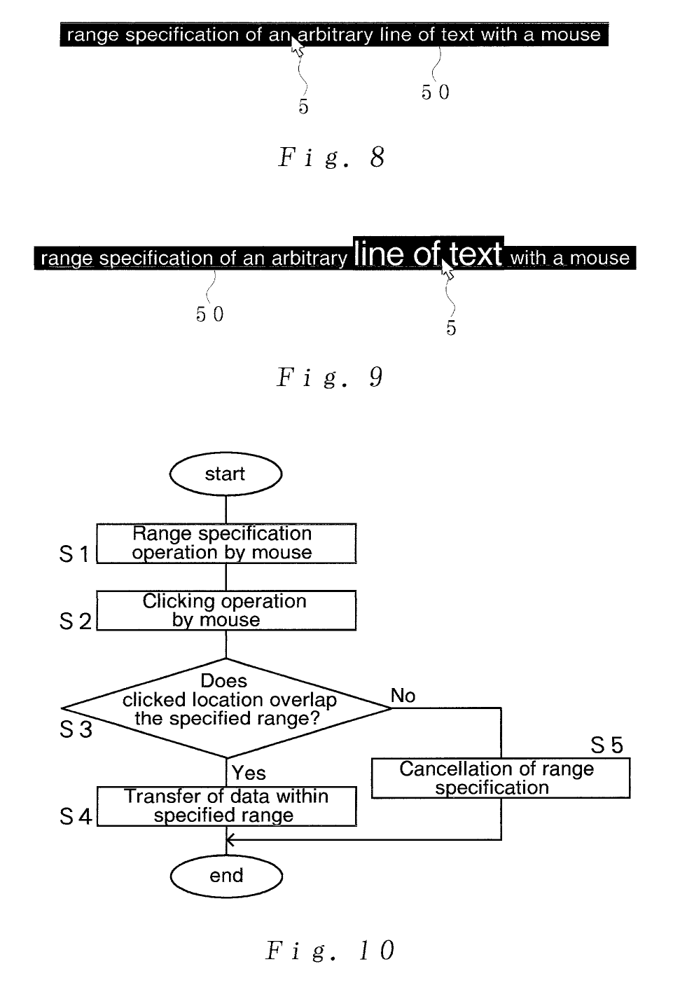

Mouse program 30 is shown in the form of a flow chart in FIG. 10. An operator specifies the range of a document displayed on WWW browser 4 by operating mouse 1 (Step S1). Here, the range is specified for the range specified area of the displayed document, “range specification of an arbitrary line of text with a mouse”. The line of text of this range specified area 50 is highlighted. In the case range specification is not performed successfully, the operator can redo range specification. Next, the operator operates mouse 1 to move the mouse cursor onto the line of text of range specified area 50. Here, although the shape of the mouse cursor changes to an arrow-shaped mouse pointer 5, an explanation regarding this point is omitted. A clicking operation using the left button of mouse 1 is performed on the highlighted line of text, namely within the specified range (Step 2) Furthermore, although the case of all characters being displayed with the same font size is shown in FIG. 8, a similar range specification can be performed even in the case in which the font size of the words “line of text” that constitute only one range specified area of the highlighted line of text are large as shown in FIG. 9.

A judgment is made as to whether this click location is overlapping the specification range by the mouseUp event in Step S2 (Step S3). As is clear from FIG. 5, in the case of taking the rectangular range having coordinates A (X1, Y1), B (X1, Y2), C (X2, Y2) and D (X2, Y1) to be range specified area 50, in the case of a clicking operation outside range specified area 50 such as point J (X4, Y4), the data within range specified area 50 having coordinates A, B, C and D cannot be transferred to HTML editor 40, but can be transferred by a clicking operation inside range specified area 50 as in the manner of point I (X3, Y3). In FIG. 6, since the mouse cursor (mouse pointer 5) is over the line of text of range specified area 50, a judgment of valid (true) is made and the line of text of range specified area 50 is copied to HTML editor 40 (Step S4). This state is represented in FIG. 7. Copied data 51 is displayed inside frame 506 which is colored inside (color attributes are specified in a table tag). In addition, time and date 507 at the time of copying, title 508 of the copy source in the form of WWW page 57, and link 504 of the copy source in the form of WWW page 57 are also displayed.

In the case of an HTML editor, by opening a saved file from a WWW browser, other data can be accessed from that file provided a hyper link is described. However, even if the file is an HTML document, other data cannot be accessed in the case of that only citing ASCII text. Even if desiring to access the original text at a later date, this is not possible unless the URL is known. In this embodiment, an anchor is embedded to the original text when data is transferred to the HTML editor. Thus, when desiring to access not only data 51 that was partially copied, but also the entire text of the source of the copy in the form of WWW page 57 at a later date, this can be easily accessed from link 504. Furthermore, a design can also be employed in which the contents of frame 506 can be used as a link by setting off the URL of the original text with specified anchor tags.

Furthermore, in the case of an operator performing a clicking operation at a location outside range specified area 50 without moving the mouse cursor over the line of text of range specified area 50, a result of invalid (false) is generated for the judgment in Step S3 causing the above range specification to be canceled (Step S5).

When looking at the processing process by mouse program 30 from the viewpoint of a mouse event, the process becomes as described below. Namely, when a cursor movement or clicking operation is performed by mouse 1, input/output control unit 33 evaluates this operation and creates an information record referred to as an event followed by sending that event to event cue 34. Event cue 34 stores a plurality of events that occur with every operation of mouse 1 in the order of their occurrence. Processing judgment unit 35 extracts events from event cue 34 starting with the oldest event, decodes its contents and performs a judgment of processing corresponding to the operation of mouse 1. Those judgment results are processed into an information record referred to as a processing command that is then transferred to processing execution unit 36. In processing execution unit 36, a processing routine corresponding to the processing command is called up and executed. In addition, processing execution unit 36 transmits image information such as the specified range to input/output control unit 33. Input/output control unit 33 converts this image information into an output signal and displays it on display 11. Although a line of text in range specified area 50 is copied to HTML editor 40 in this embodiment, as will be described later, in cases such as when the transfer destination of data within the specified range can be selected, processing should be designed so that processing execution unit 36 accesses hard disk 21 to obtain the necessary information.

As has been described above, since a specified range can be expressed with multiple coordinates, whether or not a coordinate lies within the specified range can be determined by investigating the positional relationship between each of those coordinates and a coordinate when a clicking operation is performed (see FIG. 5). Thus, after specifying a range, a line of text of range specified area 50 can be transferred to HTML editor 40 simply by performing a clicking operation on that range specified area 50.

Furthermore, the present invention is also able to use a first switch for the switch of an input device. Thus, a first switch (left switch) of mouse 1 is used even in this embodiment. In the case of a three-button mouse, for example, the switch on the far left side is the first switch. In the case of a single-button mouse, that button is the first switch. This first switch is used to select an icon or line of text, and it is the most effective to assign the clicking operation in the present invention to this first switch. This is because this operation is most commonly performed with the index finger and enables the mouse to be handled with the greatest ease. If a mouse is used to select an arbitrary range for documents, images or waveform graphs that provide visual representation of sound, transferring that data to a processing program directly by using the same button as that used when selecting the range is quite helpful for the user. However, the use a first switch of a mouse for an operation other than a drag and drop operation is considered to be a kind of taboo among software engineers with respect to processing of selected lines of text (because they do not want to use said first switch for operations other than dragging and dropping). For this reason, the usage like that employed in this embodiment has previously not been considered at all. Furthermore, although also explained in the section describing a second embodiment, in the case the target of the above operation is hyper text, since operability is obtained that is similar to clicking on a link location of hypertext as has been done in the past, it is possible to realize standardization of operability.

Furthermore, although a line of text is treated as the operation target in the embodiment described above, images and waveform graphs providing a visual representation of sound and so forth can also be used as operation targets. FIG. 11 shows a still image editor 41, and the area surrounded by handle 42 and rubber band 43 is range specified area 503. In addition, although FIG. 12 shows sound editor 44 in which a sound is represented with waveform graph 45, the location of symbol 500 is the range specified area. In the case of an animated image, operation should be stopped followed by cutting out a still image, or a range specified area should be cut out from a progressive waveform graph. Those for which the range has been specified from these operation targets should be transferred to a search engine that is capable of handling them. For example, in the case a certain picture is provided, a search engine can be used that searches other pictures of similar images. Http://www.ccrl.com/amore/cats/arts/html/query.html serve as a reference for an example of this type of transfer destination. Similar applications can probably also be realized even with waveform graphs providing visual representation of sound and animated images. Furthermore, although a line of text of range specified area 50 is transferred to HTML editor 40 in the above embodiment, it can also be transferred to a document editing program such as a text editor. In addition, this copied data can be used from another software by transferring to a clipboard. In addition, in the case those programs have been started up, data of a range specified area can be transferred after starting up those programs. Furthermore, although mouse 1 along with a keyboard are represented in FIG. 3, this is because operation can be set so that mouse dragging during the range specification operation can be substituted with the arrow keys of the keyboard, and with respect to a clicking operation after specifying the range, operation can be set so that this operation is substituted with the enter key on the keyboard.

Furthermore, with respect to image processing, there are also applications in which text represented with images is transferred to a search engine after recognizing that text.

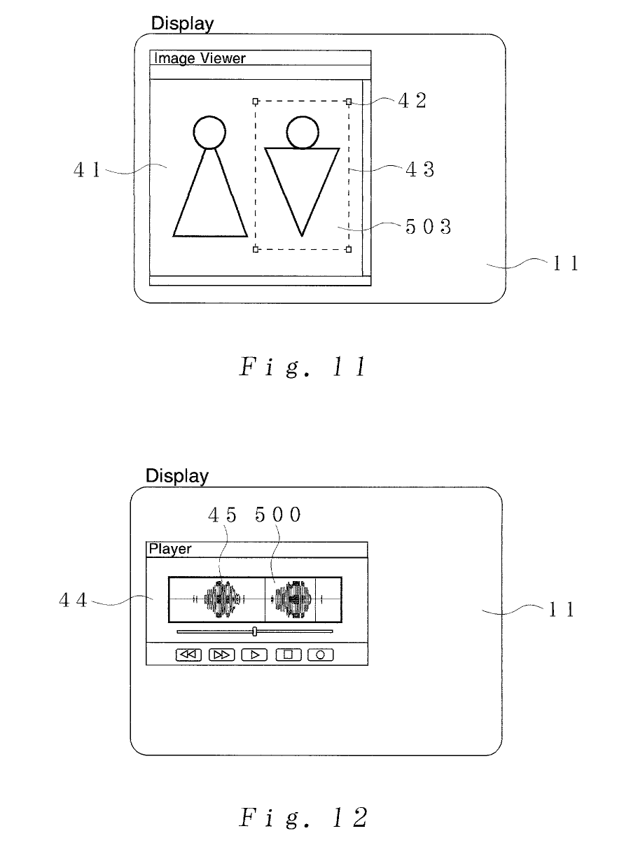

Next, in the embodiment represented with FIG. 13, in the case a range specification operation is performed which uses the rectangular range having coordinates A, B, C and D for the specified range, this embodiment is characterized by automatically enlarging the range specified area in the lateral direction by distance PX and in the vertical direction by distance PY. As a result, a rectangular range having coordinates E (X1−PX, Y1−PY), F (X1−PX, Y2+PY), G (X2+PX, Y2+PY) and H (X2+PX, Y1−PY) becomes a new enlarged range specified area.

In the case of a clicking operation at point J (X4, Y4), data within a rectangular range having coordinates A, B, C and D can inherently not be transferred to a transfer destination (see FIG. 5), and the clicking operation is required to be within the rectangular range as in the case of point I (X3,Y3). According to this embodiment, however, even if a clicking operation is performed at point J, namely at a point within enlarged range 52, data can be transferred. Consequently, even an operator who is not familiar with the operation of a mouse or other pointing device can perform this operation without becoming overly concerned.

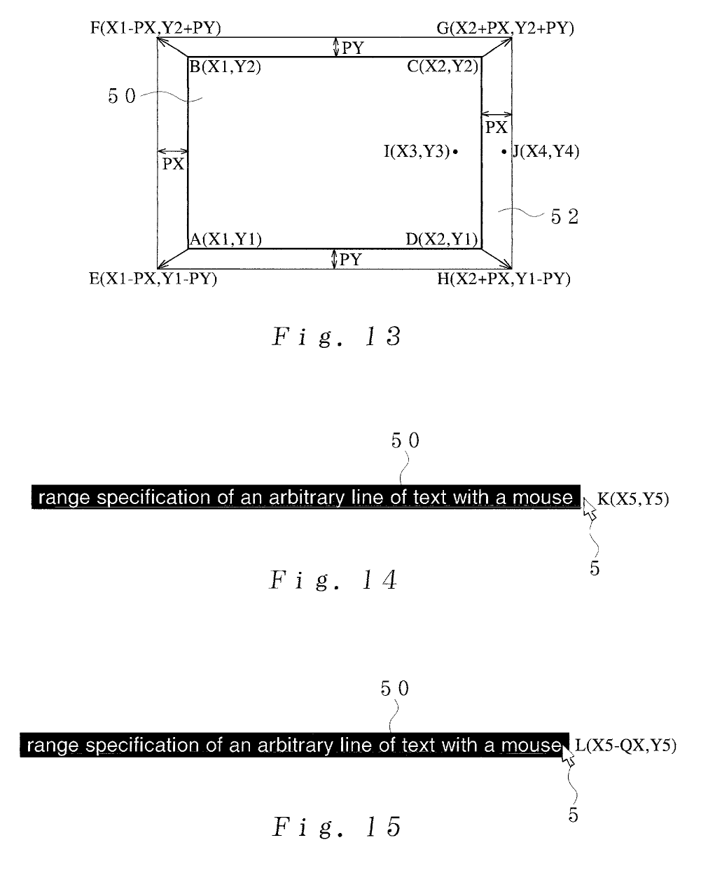

Next, in the present invention, the pointer of an input device can be moved within a specified range after specifying that range. The following provides an explanation of an embodiment of this. FIG. 14 is a drawing showing a line of text of range specified area 50 and mouse pointer 5 at mouseUp coordinate K (X5, Y5) in a range specification operation. FIG. 15 is a drawing showing the state in which mouse pointer 5 has been automatically moved to coordinate L (X5−QX, Y5) within the specified range following the above operation. The distance between coordinate K and coordinate L is QX, and in the case of performing a range specification operation from left to right, mouse pointer 5 is set so as to move by distance QX in the negative direction of the X coordinate. With respect to a range specification operation from the opposite direction, mouse pointer 5 should be set to move by distance QX in the positive direction of the X coordinate.

Consequently, an operation for moving mouse pointer 5 to inside a specified range is not required prior to a mouse clicking operation, and data can be transferred by performing a clicking operation immediately after specifying the range. Furthermore, the example here shows the mouse cursor set to change to an arrow-shaped pointer after specifying the range. In addition, with respect to the Y direction, correction can be made such that mouse pointer 5 is made to move to an intermediate position based on the height of the specified range.

Next, the present invention can be made to specify a range according to predetermined rules when a switching operation is performed at an arbitrary position where the range is desired to be specified. Predetermined rules refer to, for example, rules which specify the range by a certain number of pixels to the left and right and a certain number of pixels up and down using the clicked position as the center if the input device is a mouse and the above operation target is an image. In addition, if, for example, the above operation target is a waveform graph providing a visual representation of a sound, the above-mentioned predetermined rules may be those that specify the range until areas where there is no sound to the left and right using the clicked position as the center. Thus, since a dragging operation is not required for specifying the range, the operation becomes easier. A touch panel operated by pressing with the finger is a preferable user interface for this.

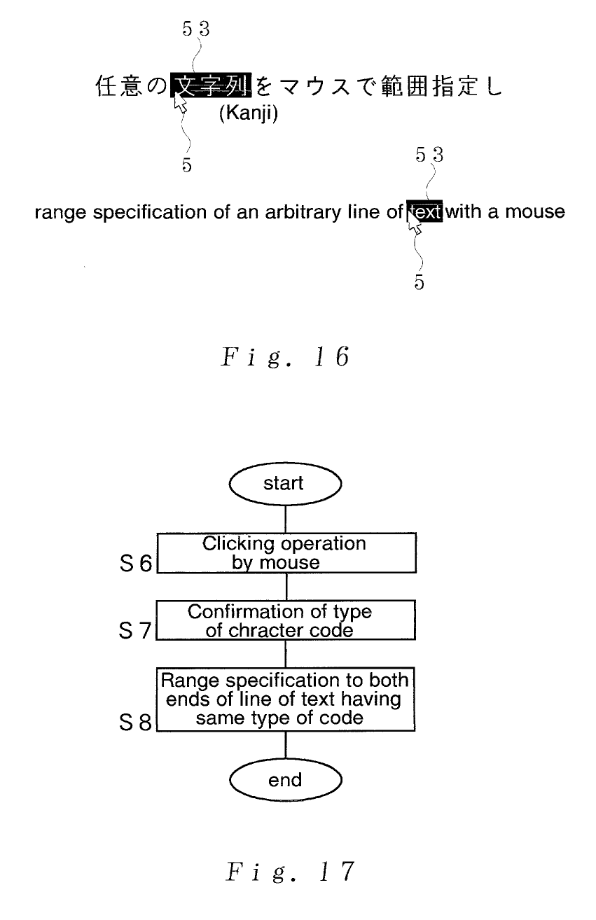

The following provides an explanation of the present embodiment using FIGS. 16 and 17. FIG. 16 is a drawing showing a line of text of range specified area 53 and mouse pointer 5. FIG. 17 is a flow chart of a mouse program for realizing this range specification. In the past, range specification had been performed by going through a series of operations consisting of mouseDown, drag and mouseUp. However, the specified range was made to be set according to predetermined rules such as extracting a word at the location of a clicking operation when performing a clicking operation at a location where the range is desired to be specified. Since these predetermined rules differ depending on the language, the following provides an explanation of this using examples in the order of Japanese and English.

An operator performs a clicking operation by a mouse on a sentence displayed on a display (Step S6). The mouse program confirms the type of character code of the clicked location (Step S7). The type of character code refers to the type of character such as Japanese Kanji, Hiragana or Katakana. If it is judged that the type of character code at the location that has just been clicked is Kanji, the mouse program looks at the character codes to the right and left of the clicked location and specifies the range until there are no more Kanji codes (Step S8). As a result, the range can be specified with a single clicking operation even for combinations of four Kanji and so forth. By continuing to perform a clicking operation, data within the specified range can be transferred.

In addition, if the sentence displayed on the display is an English sentence written with letters of the alphabet, since there are spaces between each word, the range can be specified for words by using those spaces.

Furthermore, when performing a switching operation at a location for which the range is desired to be specified, this switching operation may be characterized by first setting the specified range according to predetermined rules, and subsequently transferring the data within the specified range to a transfer destination. More specifically, this consists of specifying the range when a mouseDown event occurs, and transferring data within the specified range to a transfer destination when a mouseUp event occurs. In this case, the coordinates at which the mouseUp event occurs is within the range specified area.

Next, the present invention can be made to perform range division on the operation target of an input device according to predetermined rules, and if an arbitrary divided range among the plurality of divided ranges is instructed by the input device, use that divided range as the specified range. For example, if a Japanese sentence is the operation target, after transforming the sentence into a so-called form in which spaces are left between words by performing morphemic analysis, or if the operation target is an English sentence, setting off the individual words with spaces and so forth, by, for example, pointing or clicking a mouse cursor (pointer) or pressing the tab key or right or down arrow keys of a keyboard, the specified range continues to move. Thus, in addition to being able to eliminate the bother of specifying the range by a dragging operation, it is extremely easy to redo range specification. A touch panel operated by pressing with the finger is a preferable user interface for this. This is also effective on comparatively small screens installed in cellular telephones and other portable terminals. In addition, in the case of specifying the range of an operation target on a television screen, etc., this operation can be performed with a remote controller. Furthermore, in the case of a Japanese sentence, processing may be performed following morphemic analysis that connects an adverb following a common noun to that common noun or connects a post-positional auxiliary word following an adjective to that adjective and so forth.

An explanation of this embodiment is provided using FIG. 18. Morphemic analysis and so forth is performed when a document arbitrarily selected by an operator is read, and although not displayed on the screen, demarcations are inserted between the words in the sentence. Thus, instead of specifying the range when a mouse clicking operation is performed, the specified range is selected with the mouse from among a range that is already demarcated. Furthermore, the range may also be made to be selected by an operation in which a mouse pointer is placed over a character (occurrence of an onMouseOver event and so forth). In addition, range selection can be performed by pressing with the finger in a touch panel and so forth. Symbol 501 is the demarcated range.

In the next embodiment, range specification is set according to predetermined rules by performing a first clicking operation at a location where the range is desired to be specified, and performing the next clicking operation within a predetermined amount of time.

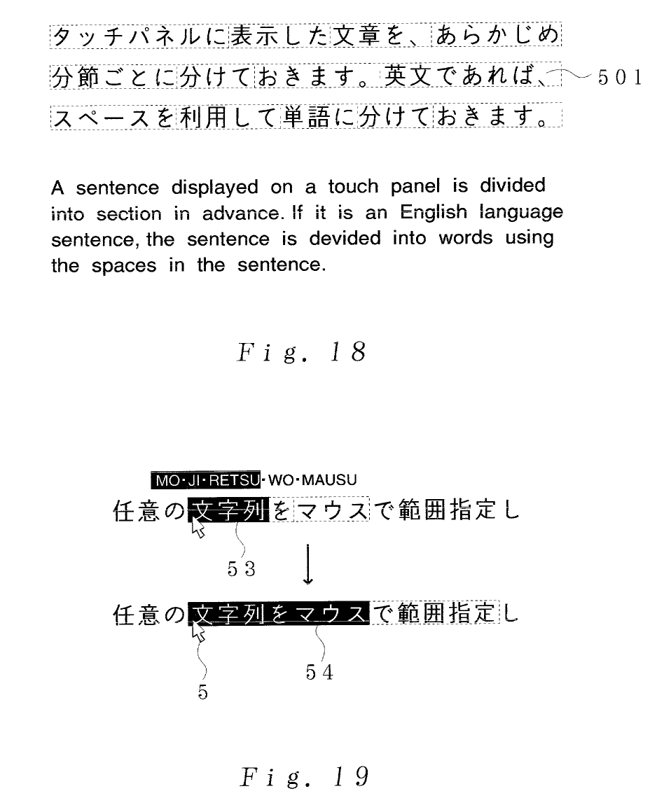

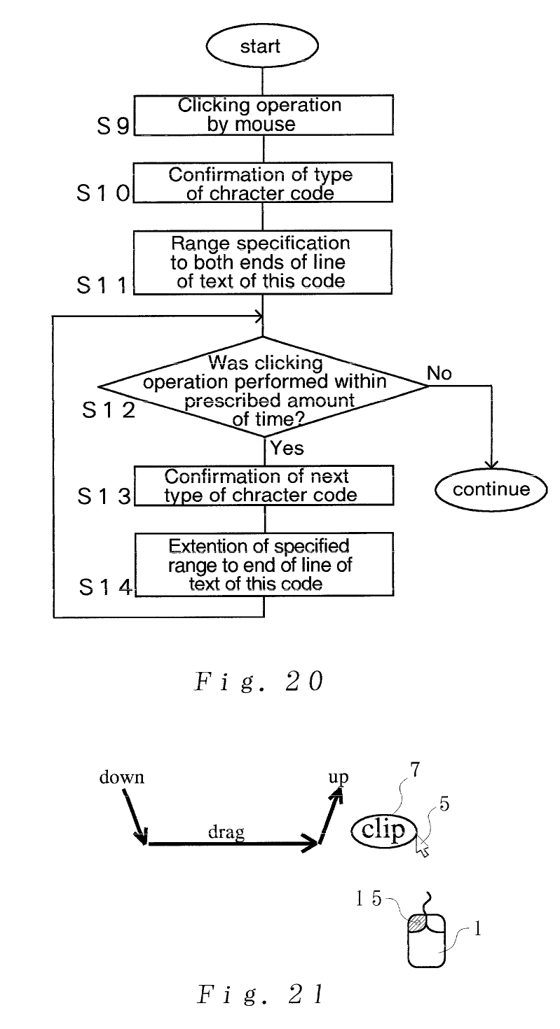

FIG. 19 illustrates the case of specifying the range with a first single clicking operation (range specified area 53) followed by extending range specification to a stipulated range with second and third clicking operations (range specified area 54). FIG. 20 is a flow chart for the mouse program. An operator performs a clicking operation by a mouse on a sentence displayed on a display (Step S9). The mouse program confirms the character code of the character “MO” at the clicked location (Step S10). The mouse program then looks at the character codes of the characters to the left and right of the clicked location and specifies the range until there are no more Kanji codes (Step S11). Subsequently, when a second clicking operation is performed, the mouse program investigates the amount of time that has elapsed since the first clicking operation (Step S12), and if it within a predetermined amount of time, it confirms that the type of character code of the next character “WO” is Hiragana (Step S13), extends the range until there are no more Hiragana codes and uses the area “MOJIRETSU-WO” as the specified range (Step S14). Moreover, if a clicking operation is again performed within a predetermined amount of time (Step S12), the mouse program confirms that the type of character code of the next character “MA” is Katakana (Step S13), extends the range until there are no more Katakana codes and uses the area through “MOJIRETSU-WO-MAUSU” as range specified area 54 (Step S14). Moreover, although this processing is repeated if clicking is continued within a predetermined amount of time (the specified range is extended to the range indicated with broken lines in FIG. 19 in the case this processing is repeated twice), if a clicking operation is performed after a predetermined amount of time has elapsed, this range specification is either canceled or, if the coordinates when the clicking operation was performed are within the specified range, data within the specified range is transferred to a transfer destination.

In addition, the mouse program may be defined to use the area through range specified area 53 for the specified range by performing the clicking operation twice, namely by double-clicking, within a predetermined amount of time. In this case, the range is specified through range specified area 54 by performing the clicking operation four times.

Furthermore, in the present embodiment, CPU 2 uses real-time clock 25 shown in FIG. 3 for a timer.

Furthermore, the present embodiment is also effective in the case of using a touch panel for the pointing device. This is because the range specification operation as well as transfer of data within the specified range can be performed simply tapping the panel with a finger or pen. In addition, the present embodiment also has the potential for being extremely effective in the future as well since it allows the range specification operation to be performed easily even for the pointing device of a head-mounted display used with a wearable computer.

Next, FIG. 21 shows processing performed that transfers data within a specified range to a transfer destination by displaying a search switch 7 able to be operated by mouse 1 on a display screen and pressing this search switch 7 at the time of a mouseUp event at the end of a range specification operation. Here, in the case of clicking at a location outside search switch 7, the range specified area is canceled and search switch 7 is deleted. In this manner, the range specified area and search switch 7 both appear and disappear. Furthermore, search switch 7 does not have to be that which is displayed as the result of a mouse event as described above, but rather may also be, for example, permanently provided adjacent to the tool bar of a browser that displays a WWW page that is the target of the operation. In any case, this type of search switch should be displayed on the display screen. In addition, a plurality of these search switches 7 can also be displayed, each having different transfer destinations.

As indicated in this embodiment, the area over a mouse switch 7 that is displayed at the time of a mouseUp event at the end of a range specification operation can also be considered to be within the specified range, namely a portion of a range specified area.

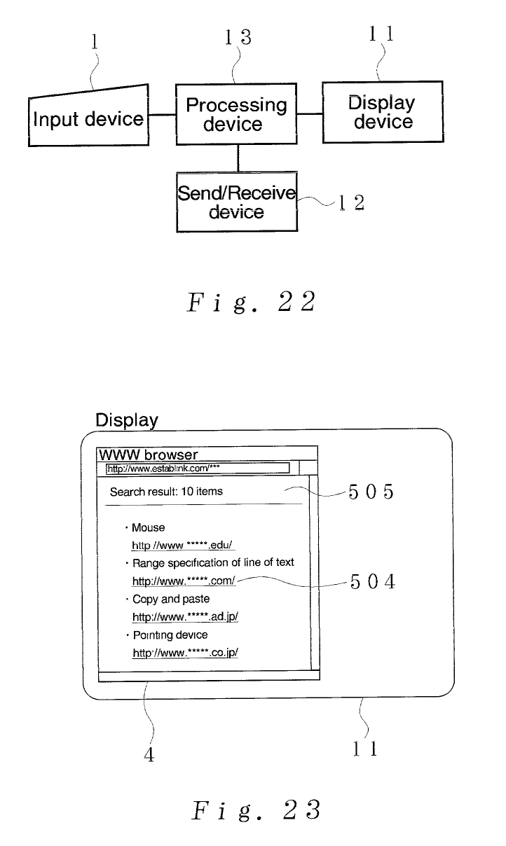

FIG. 22 shows the entire constitution of a data transfer device as claimed in a second embodiment. Input device 1 is a pointing device for performing range specification and switching operations. Display device 11 is for display HTML documents that are the operation targets of input device 1 along with the cursor of input device 1.

Range specification is first performed for a sentence displayed on display device 11 using the cursor of input device 1 by operating input device 1. This range specified area is made to highlight a line of text. If range specification is performed unsuccessfully, the operator can redo range specification. Next, processing device 13 incorporates the line of text of the range specified area and uses it as a keyword to transfer from an incorporated browser (WWW browser) to another computer connected to a network serving as the search destination via send/receive device 12. Processing device 13 then receives search results from the above search destination, and displays the results in the form of page 505 of the search results on WWW browser 4 of display device 11. As shown in FIG. 23, link 504, which can be selected by a pointing device, is displayed on WWW browser 4. When this is clicked by input device 1, WWW browser 4 obtains the corresponding document from the link destination and displays that document.

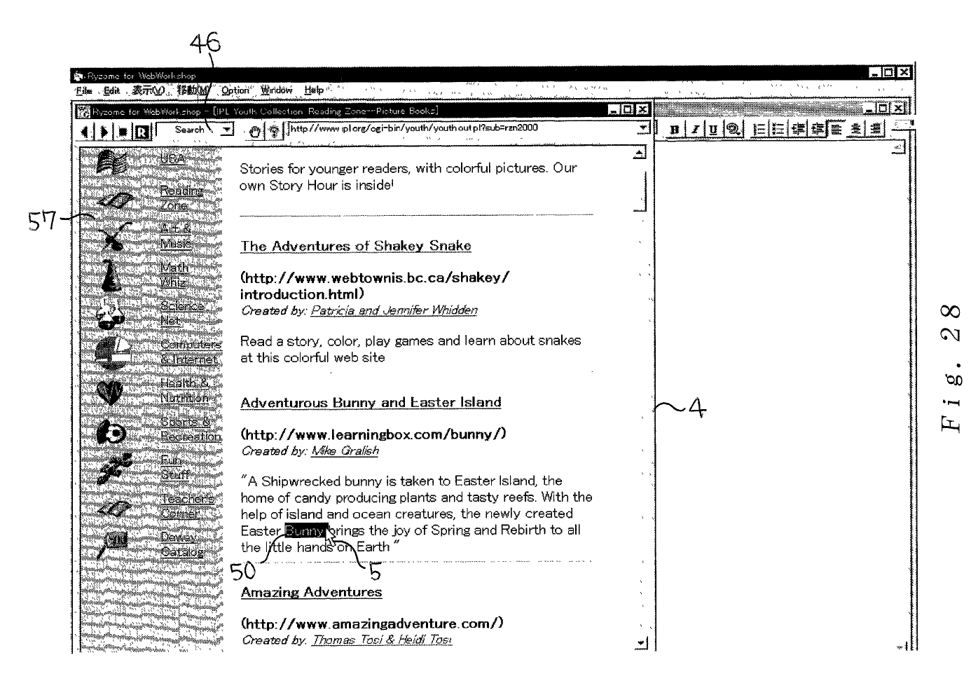

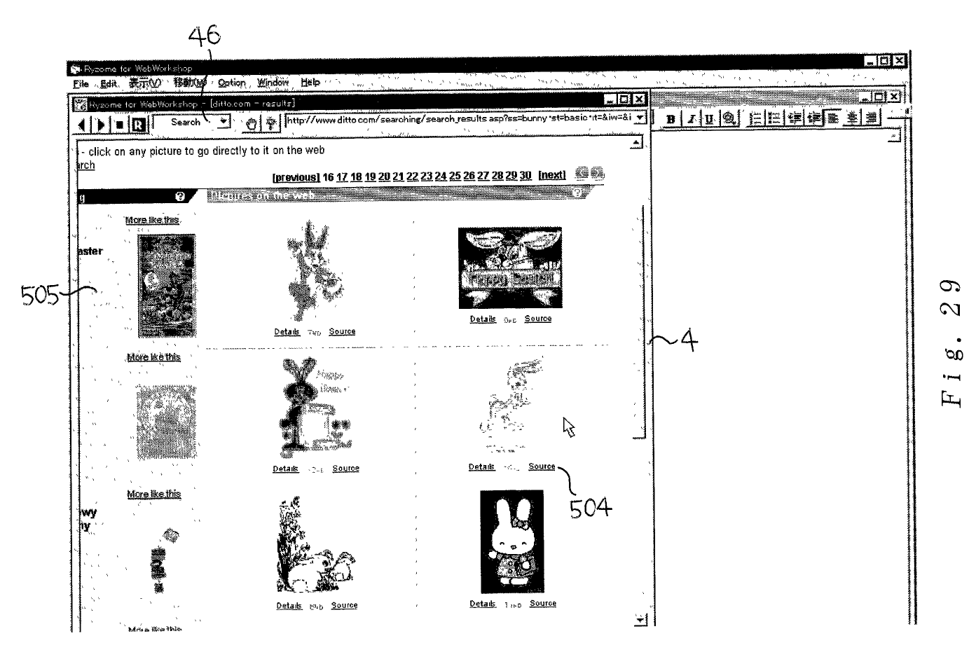

Processing device 13 of FIG. 22 can also be realized using CPU 2. The next embodiment is an application software that transmits range-specified data on WWW browser 4 to a search engine on the Internet via WWW browser 4 using CPU 2, and displays hyper text of the results of that search on WWW browser 4, and FIGS. 28 and 29 show actual screen displays. Furthermore, processing device 13 can also be composed by hardware logic instead of using CPU 2.

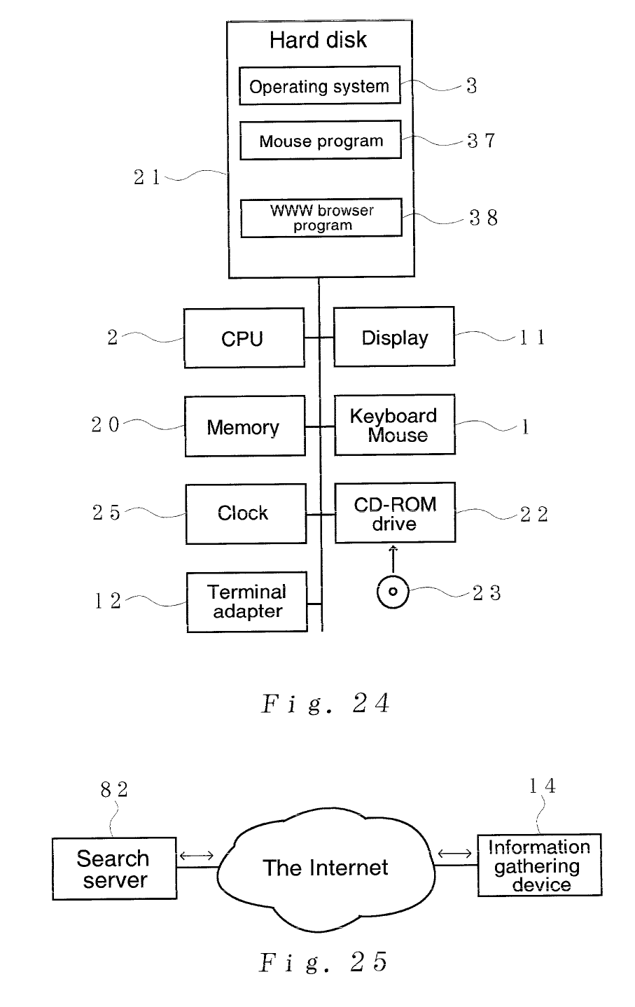

Memory 20, a storage device in the form of hard disk 21, an input device in the form of mouse 1, a display device in the form of display 11, and CD-ROM drive 22 are connected to CPU 2. Operating system OS3, a data transfer program in the form of mouse program 37 and WWW browser program 38 are stored in hard disk 21. This mouse program 37 and WWW browser program 38 are installed from CD-ROM 23 via CD-ROM driver 22. Furthermore, mouse 1 here is a two-button mouse. In addition, information gathering device 14 in this embodiment is connected to the Internet as shown in FIG. 25, and gathers information using search server 82 similarly connected to the Internet.

Range specified area 50 is shown in FIG. 28 on WWW page 57 displayed on WWW browser 4. Here, the actual state is shown of being about to perform a click by the left mouse button following completion of range specification. Page 505 of the search result displayed on WWW browser 4 is shown in FIG. 29.

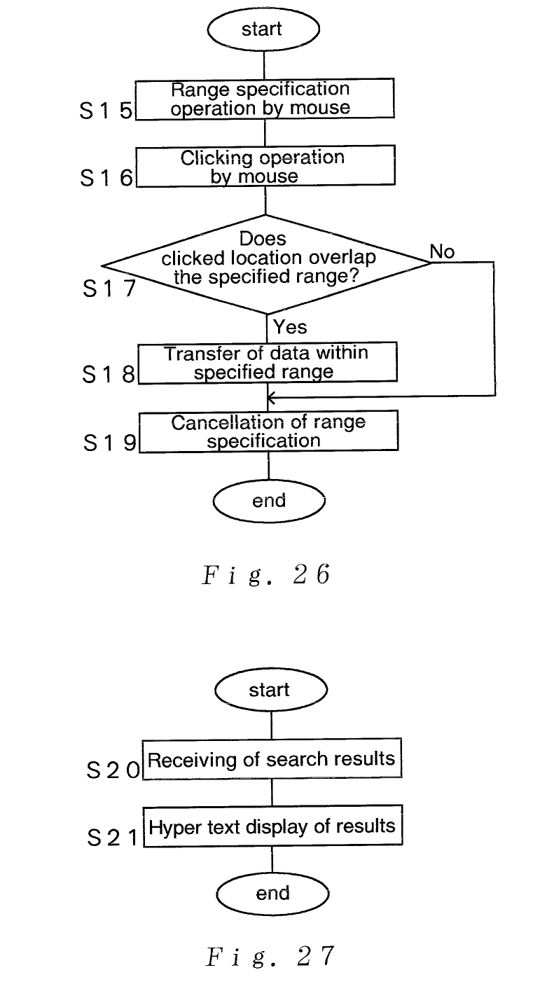

Mouse program 37 is shown in the form of a flow chart in FIG. 26. An operator specifies the range for a document displayed on WWW browser 4 by operating mouse 1 (Step S15). Here, the range is specified for the “Bunny” portion of the displayed document. The line of text of this range specified area 50 is highlighted. However, since range specification can also be performed by using the Shift key and arrow keys of a keyboard in the manner of a text editor or HTML editor, this procedure may also be employed. Next, the operator moves the mouse cursor over the line of text of range specified area 50 by operating mouse 1. The operator then performs a clicking operation using the left button of mouse 1 over the highlighted line of text, namely within the specified range (Step S16).

A judgment is made as to whether or not the clicked location is overlapping the specified range by the mouseUp event in Step S16 (Step S17). In FIG. 28, this judgment is valid (true) since the mouse cursor (mouse pointer 5) is over the line of text of range specified area 50, and the program transfers the line of text of range specified area 50 to search server 82 on a network serving as the search destination via WWW browser 4 (Step S18), and range specification is canceled (Step S19). Furthermore, in the case the operator performs a clicking operation at a location outside range specified area 50 without moving mouse pointer 5 to over the line of text of range specified area 50, since the result of the judgment in Step S17 is invalid (false), the above range specification is canceled (Step S19). In this manner, a line of text within range specified area 50 can be transferred to search server 82 simply by performing a clicking operation over a range specified area after specifying that range.

Page 505 of the search result from this search server 82 is then displayed on WWW browser 4.

Furthermore, a selected line of text can be sent to search server 82 by continuing to specifying a range on that page 505 and performing a clicking operation over that range specified area, or a selected line of text can be sent to search server 82 by performing a similar operation on the page of a displayed link destination by clicking link 504. In this manner, regardless of the page, the operation of selecting a line of text from the page currently being viewed and transferring that line of text directly to search server 82 is extremely smooth.

Furthermore, a first switch is used for the switch of the input device in this embodiment. Since this first switch is used to click a hyper link, by assigning a clicking operation following range specification to this first switching operation, standardization can be obtained between both operations, and other related pages can be accessed from areas where a link is not provided in a document as if a link was actually provided. An operator is able to intuitively understand this operation, and the operation itself is extremely easy. There has previously been no such means for realizing this degree of favorable operability for an operation target arbitrarily selected by a user. Furthermore, the enter key of a keyboard may also be set to be used in place of the clicking operation following the range specification operation. In the embodiment described above, although a line of text is treated as the operation target, images or waveform graphs providing visual representations of sound and so forth can also be operation targets.

Mouse program 37 is integrated into a single unit with the WWW browser, and can be supplied by plugging in the WWW browser or by using a permanent stationed program or mouse driver independent of the WWW browser. Although it is arbitrary as to what form is adopted, in the case of being independent of the WWW browser, the range specification operation can be performed on dictionary software, text editors, image editors and other general software.

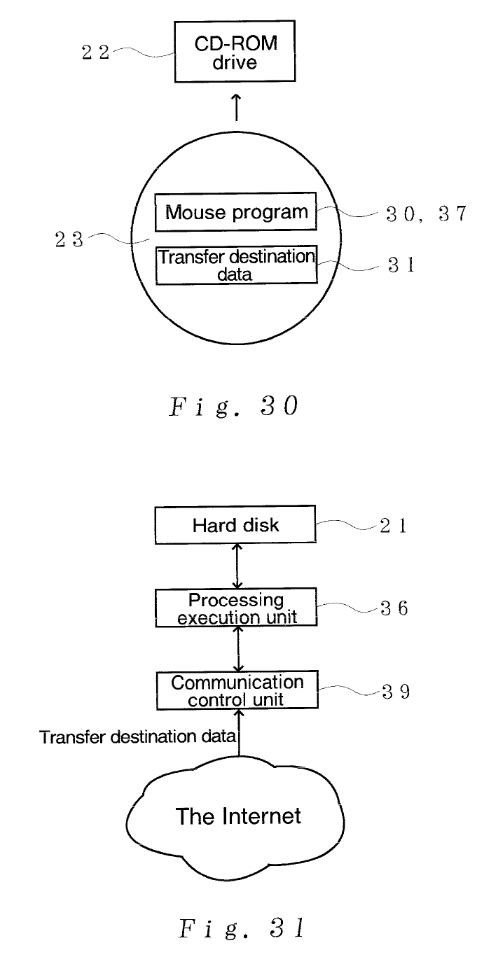

Incidentally, in the category of recording media, the present invention can also be defined as a recording medium on which a program is recorded for performing processing for transferring data for which the range has been specified by an input device to a transfer destination to be described later in a computer equipped with an input device, and that recording medium is recorded with a program for enabling a computer to perform preparing transfer destination data in advance, displaying an operation target arbitrarily selected by a user, judging whether coordinates when a switching operation was performed by an input device for said operation target are within a range specified with a range specification operation by an input device prior to this switching operation, and transferring data within said specified range to a transfer destination based on the above transfer destination data in the case said coordinates are within the specified range. Here, data relating to transfer destinations is provided on the recording medium. A recording medium in the form of CD-ROM 23 represented in FIG. 30 is recorded with mouse program 30 or 37 along with transfer destination data 31. Mouse program 30 or 37 and transfer destination data 31 are installed in hard disk 21 via CD-ROM drive 22.

In contrast, the present invention can also be defined as a recording medium on which is recorded a program for enabling a computer having transfer destination data and an input device to perform processing for transferring data for which the range has been specified by an input device to the above transfer destination, and that recording medium is recorded with a program for enabling a computer to perform displaying an operation target arbitrarily selected by a user, judging whether coordinates when a switching operation was performed by an input device for said operation target are within a range specified with a range specification operation by an input device prior to this switching operation, and transferring data within said specified range to a transfer destination based on the above transfer destination data in the case said coordinates are within the specified range. Here, data relating to transfer destinations is not provided on the recording medium and is made to be acquired separately. For example, the above data can be installed before or after from a separate recording medium from the recording medium containing mouse program 30 or 37. Data can also be suitably introduced as necessary by installing later via a network. FIG. 31 shows a processing block in the case of communication control unit 39 receiving transfer destination data from a WWW server not shown via the Internet, and processing execution unit 36 storing this data on hard disk 21.

Furthermore, communication control unit 39 is able to receive WWW pages from a WWW server via the Internet, processing execution unit 36 is able to extract the transfer destination data described on the WWW page, and this data is then used by mouse program 37 and so forth. Processing execution unit 36 may also transfer destination data to destination setting unit 300 to be described later, and be registered on a menu. In addition, mouse program 37 itself may be installed by being downloaded via the Internet, or that which has been transmitted via a network in the form of a mouse control may be run directly. A specific proxy server can be specified for receiving a WWW page, and this proxy server can write the script program of this mouse program onto a WWW page that passes through it. For example, Javascript can be used for this purpose.

However, with respect to the transfer destination of data of a range specified area, in the case of, for example, search server 82, it is preferable to allow a user to select which search server is to be used among a plurality of search servers 82.

Therefore, an arbitrary transfer destination among a plurality of transfer destinations is allowed to be set for the transfer destination. As an embodiment of this, FIG. 32 is a drawing showing hard disk 21. Mouse program 37 is provided with transfer destination setting unit 300, and as a result, when a clicking operation is performed within the specified range, either a preset default transfer destination can be set, or a transfer destination can be selected and specified directly.

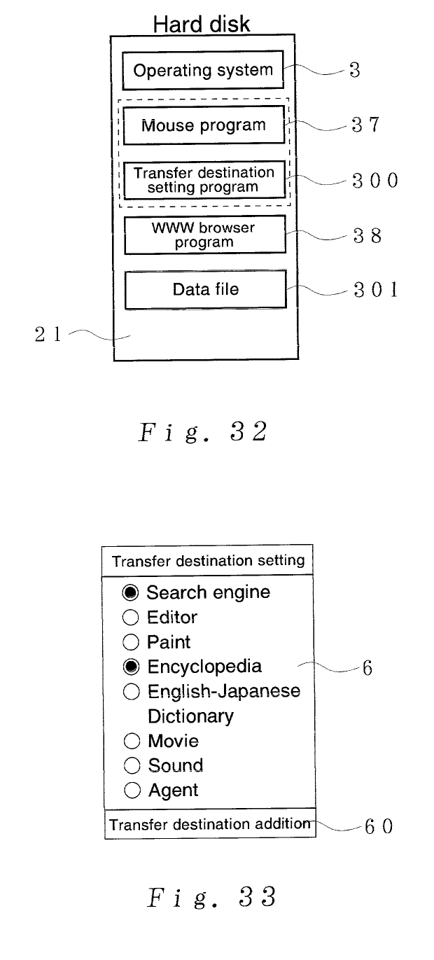

When the above transfer destination setting unit 300 is started up, dialogue box 6 for setting the transfer destination default as shown in FIG. 33 is displayed. In this embodiment, when a clicking operation is performed within a range specified area, the data of the range specified area is transferred to a plurality of transfer destinations checked with the radio button consisting of a search engine and encyclopedia. Furthermore, the selections show an example of settings in which the search engine is a search system available on the Internet, the editor, paint, movie, sound and English-Japanese dictionary are different applications installed on hard disk 21, the encyclopedia is a CD-ROM dictionary placed in CD-ROM drive 22, and the agent is an agent program for on-line shopping. In the case of installing a search engine on hard disk 21, a menu may be displayed for specifying this search engine to search its own directory. Transfer destination addition menu 60 is provided on the bottom line for this purpose.

Furthermore, in FIG. 33, both the search engine and encyclopedia are involved in searching, and examples of processing for receiving and displaying a plurality of search results because of this include changing the page for each search destination, sorting with folders, dividing the same page into frames and displaying a series of search results on the same page.

Furthermore, search server 82 can also be made to be arbitrarily registered or selected by a user. Namely, in addition to making it possible to register a plurality of transfer destinations, anyone of them can be set as the transfer destination. In this case, the transfer destination is stored in data file 301 by registering with transfer destination setting unit 300.

Although the preceding sections have provided explanations of different modes for carrying out the invention using FIGS. 6 and 7 and FIGS. 28 and 29, it can be understood from these screen captured images that the software produced by the inventor of the present invention has a function that copies range specified area 50 to HTML editor 40, as well as a function that transmits range specified area 50 to search server 82 and displays hyper text of those search results on WWW browser 4. Menu 46 is provided for switching between these two functions. However, software can also be provided equipped with each of these functions independently.

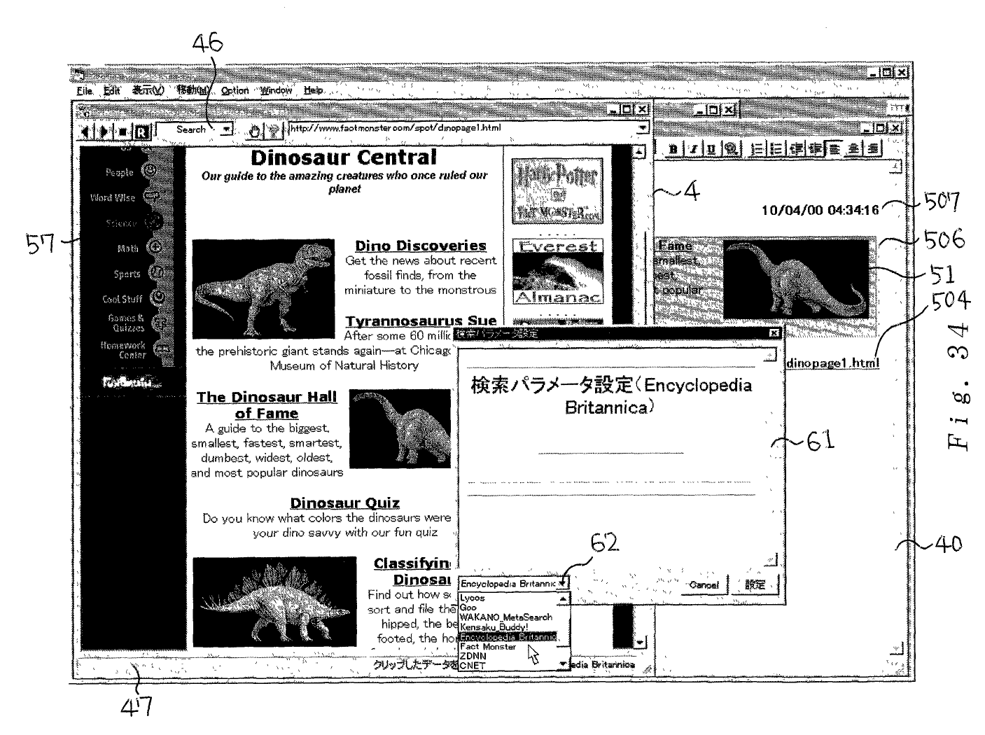

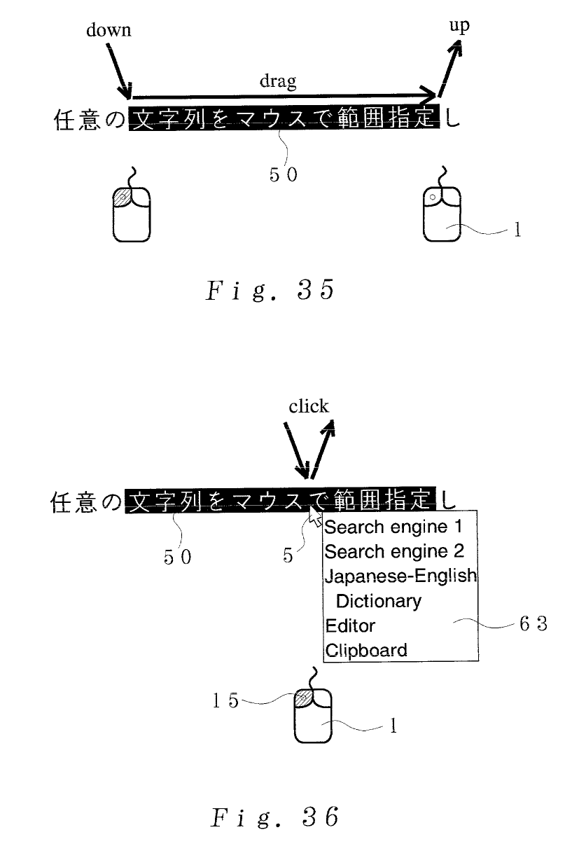

FIG. 34 shows the actual screen display of application software in which a function for enabling a user to select and specify a transfer destination is added to the function that transfers range specified area 50 to search server 82 and displays hyper text of those search results on WWW browser 4. Status bar 47 of WWW browser 4 is clicked to display dialogue box 61 for selecting and specifying a transfer destination. Dialogue box 61 is provided with drop-down menu 62, and a user is allowed to select a transfer destination here. In this example, http://search.britannica.com/search is selected, and queries are transmitted here.

Furthermore, FIG. 34 represents the state of specifying a search destination by switching menu 46 to search and displaying dialogue box 61 after copying a portion of the text and image of WWW page 57 displayed on WWW browser 4 onto HTML editor 40. The display of drop-down menu 62 is based on the contents of a setting file not shown named SearchOption.ini.

The next embodiment indicates that in which, in the case of specifying a range with a mouse (FIG. 35) followed by performing an operation in which a first switch (left button switch) 15 of a mouse provided with two left and right buttons is pressed within this range specified area 50, a transfer destination close to the pressed location is displayed as pop-up menu 63 (FIG. 36) that can be selected by mouse 1. Furthermore, a clipboard is displayed as the transfer destination in this pop-up menu 61.

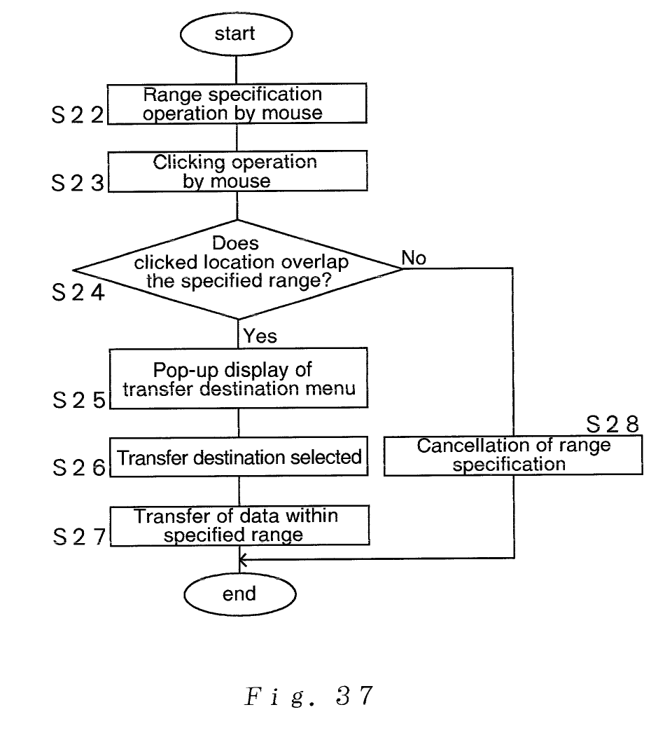

FIG. 37 shows a program for realizing this processing in the form of a flow chart. When a range specification operation is performed by mouse 1 (Step S22) followed by performing a clicking operation by left button switch 15 of mouse 1 within this range specified area 50 (Step S23), a judgment is made as to whether the clicked location is overlapping with range specified area 50 (Step S24). If it is overlapping, pop-up menu 63 of the transfer destination is displayed near mouse pointer 5 (Step S25). Once selection of a transfer destination has been performed by mouse pointer 5 (Step S26), data within range specified area 50 is transferred (Step S27). However, if the clicked location is not overlapping range specified area 50 as a result of the judgment according to Step S24, range specification is canceled (Step S28).

Thus, both data selection and transmission of data to a transfer destination selected from a menu can be performed using a procedure that is the same as the dragging operation and clicking operation using left button switch 15 of mouse 1 with which a user is familiar.

In the embodiment described above, pop-up menu 63 is displayed and a transfer destination is selected from that menu each time data is transferred. In cases when it is desired to again use a transfer destination used immediately prior to the current transfer, pop-up menu 63 must always be displayed. Although being able to freely select a transfer destination is certainly favorable, if data is to be continued to be transferred to the same transfer destination, it would be desirable to be able to perform this simply by clicking in range specified area 50. This problem applies similarly to other menu display methods, such as a method in which a menu is displayed by clicking a right button switch of a two-button mouse after placing mouse pointer 5 within range specified area 50. In this embodiment as well, it would be desirable to be able to transfer data within range specified area 50 by simply placing mouse pointer 5 within range specified area 50 and clicking the left button switch if the transfer destination is the same as that selected immediately before.

Therefore, in the present invention, together with enabling a transfer destination to be selected from a menu by displaying a plurality of transfer destinations on a menu, it also allows the most recently selected transfer destination to be treated as the default transfer destination.

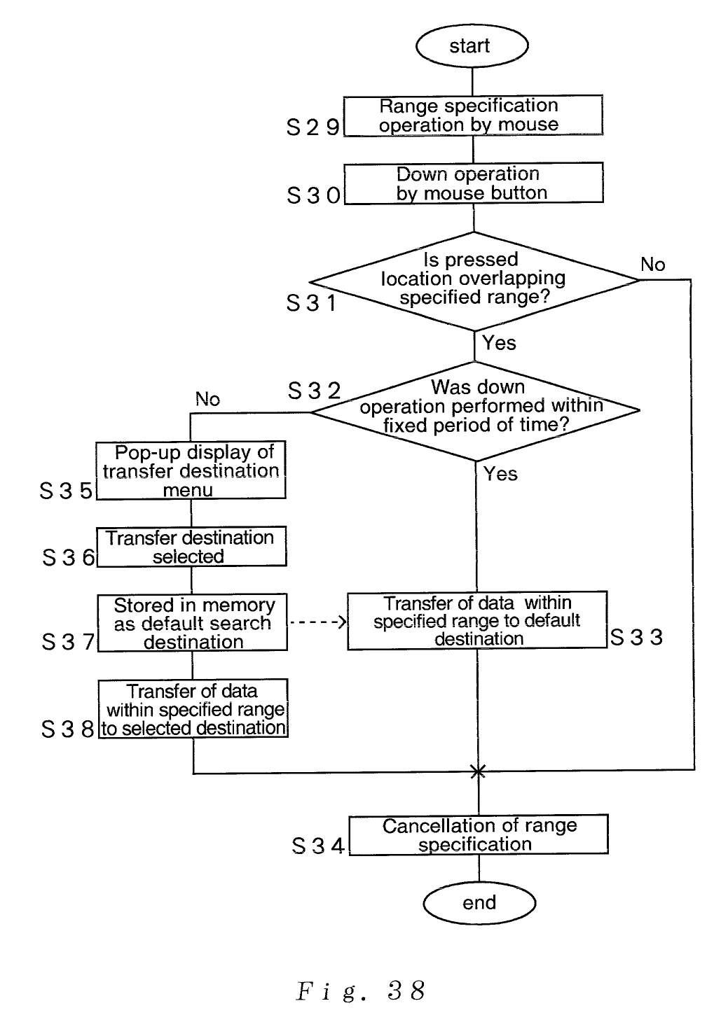

A flow chart of this embodiment is shown in FIG. 38. When a range specification operation is performed by a mouse (Step S29), and a mouseDown operation is performed by the left button of a mouse within this range specified area (Step S30), first a judgment is made as to whether the clicked location is overlapping with the range specified area (Step S31). If it is not, the program proceeds to Step S34 and range specification is canceled. If it is overlapping, a judgment is made as to whether this mouseDown operation was performed within a predetermined amount of time, namely whether the button was pressed longer or shorter than is stipulated (Step S32). Consequently, a judgment is made by measuring the amount of time from the time of the mouseDown operation to the time of the mouseUp operation. Here, in the case the clicking operation from the mouseDown operation to the mouseUp operation was performed within a predetermined amount of time, data within the specified range is transferred to the default transfer destination (Step S33) and range specification is canceled (Step S34). However, if the duration of the above clicking operation exceeds the predetermined amount of time, transfer destination pop-up menu 63 is displayed near mouse pointer 5 (Step S35), and once a transfer destination has been selected by the mouse pointer (Step S36), this is first stored in memory as the default destination (Step S37), data within the specified range is transferred to this search destination (Step S38), and range specification is canceled (Step S34).

In Step S32, in the case the clicking operation is performed within the predetermined amount of time, data is transferred to the default transfer destination. Thus, those transfer destinations that are used frequently are automatically used as the default transfer destination resulting in greater convenience.

Furthermore, together with allowing user registration of a plurality of transfer destinations and allowing a transfer destination to be selected from a menu by displaying those transfer destinations on a menu, the most recently selected transfer destination may be used as the default transfer destination.

Next, in the present invention, it is possible to perform processing that disables the operation of hyper link in the case the above operation target has a hyper link. A link in hyper text is truly difficult to specify the range. For example, this can be easily understood by trying to specify the range to be copied for a line of text in a link. This is because the link itself is inherently to be used for the purpose of being clicked. The present invention is not for following a link location provided intentionally by a page producer, but rather to enable a user to arbitrarily select data to serve as a key and use that data for searching. Thus, it becomes easier to specify data on a hyper link for the key by disabling the operation of the hyper link. Furthermore, methods for disabling the operation of a hyper link include, redrawing the screen after deleting the anchor tag of the HTML format <A HREF=“Scheme name://domain name/pass name/”></A>, redrawing the screen after commenting out the anchor tag, redrawing after substituting for the underline tag <U></U>, and ignoring the hyper link even if it is pressed with the program of the WWW browser, and so forth. In addition, in order to switch to a processing mode for disabling hyper link operation, a button should be displayed that can be clicked using a pointing device, the switch of the pointing device should be pressed continuously for a predetermined amount of time on the hyper link or on the display screen, or a hyper link operation disabling mode should be selected from a menu, and so forth. A display may be performed that makes it possible to visually determine that the hyper link of the target operation has been disabled.

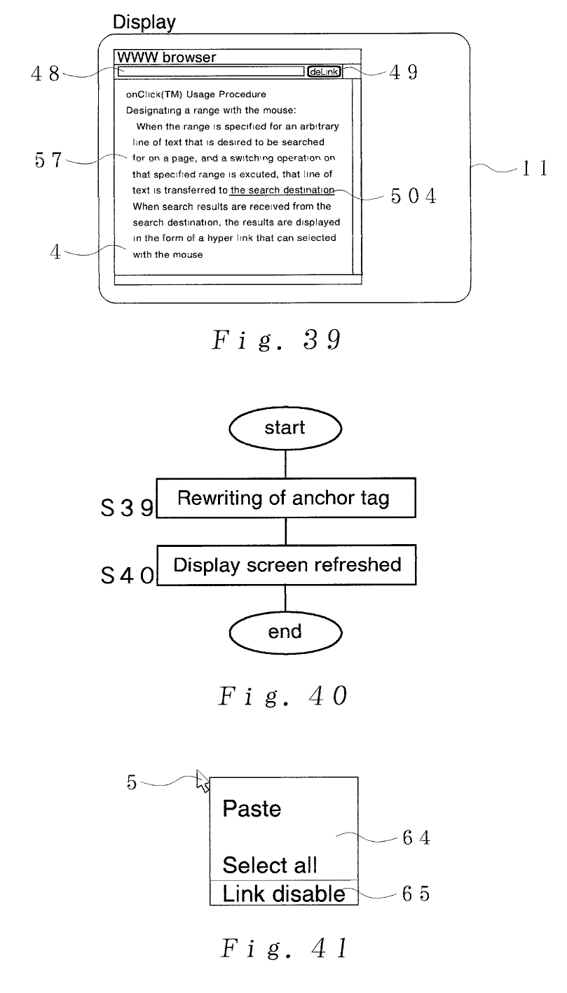

Link disable (deLink™) switch 49 is provided to the right of URL input window 48 in browser 4 of FIG. 39. This operation procedure is explained using the flow chart of FIG. 40. When link disable switch 49 is switched on, the anchor tag of link 504 of WWW page 57 displayed on browser 4 is rewritten to an underline tag (Step S39) after which WWW page 57 is redrawn (Step S40) (FIG. 39).

In addition, FIG. 41 shows an example of link disabling designed so that link disable menu 65 of pop-up menu 64 displayed by clicking the right button of the mouse is clicked with the left mouse button. Furthermore, although not shown in the drawing, a link enable menu is displayed on a pop-up menu displayed by next clicking the right mouse button.

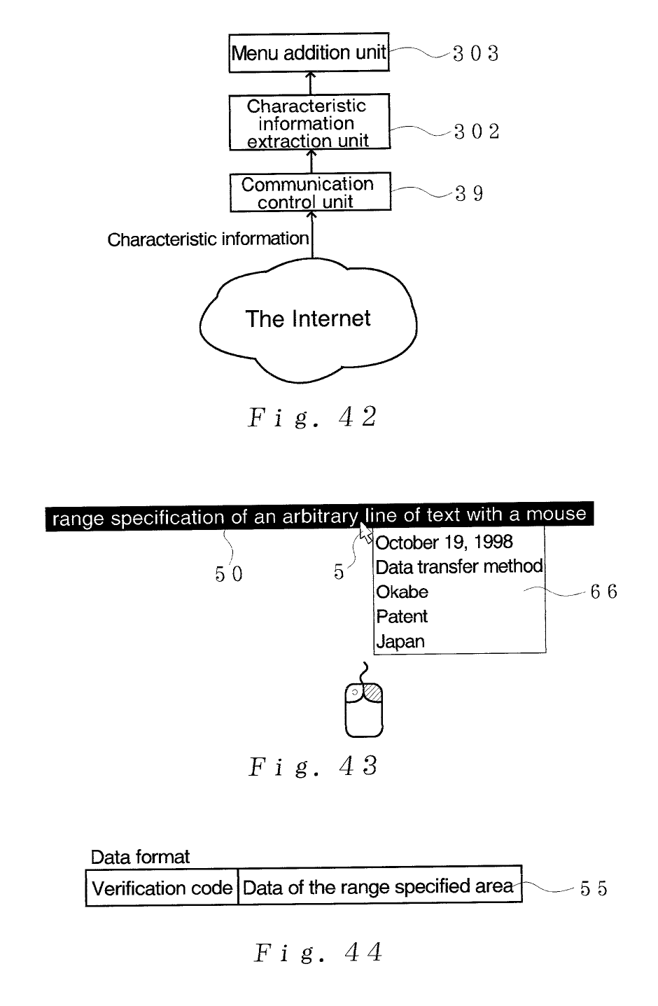

Next, the embodiment shown in FIG. 42 is a processing block in the case of communication control unit 39 receiving a WWW page from a WWW server via the Internet, transferring it to characteristic information extraction unit 302, characteristic information extraction unit 302 extracting characteristic information of this WWW page, transferring it to menu addition unit 303, and this menu addition unit 303 adding this characteristic information to context menu 66 shown in FIG. 43. This context menu 66 is not a menu listing data transfer destinations, but rather is a menu containing received characteristic information. Characteristic information selected from this menu is transferred to the search engine of the WWW server site along with range-specified data, and provided for searching.

As appears on context menu 66, five pieces of characteristic information are described on the WWW page of this example. These consist of the data on which this WWW page was produced, the page title, author, category to which the page belongs, and country of the author. In the case of, for example, the name of the author, individual prescribed tags are assigned in the manner of <author>okabe</author>, and characteristic information extraction unit 302 extracts characteristic information in the form of “okabe” from this tag. Furthermore, the portions surrounding this specific tag do not appear on the display of browser 4.

Furthermore, characteristic information such as the author name added to context menu 66 is deleted from context menu 66 in the case the page of a different WWW site is displayed by operation of browser 4. Communication control unit 39 informs menu addition unit 303 that a different WWW page has been displayed, and menu addition unit 303 then deletes the author name and so forth from the menu. If the newly displayed WWW page has characteristic information, that information is added to the menu. Tags may also be newly defined. Regardless of whether or not the browser is able to interpret this, characteristic information extraction unit 302 is able to find this tag on the WWW page.

Next, the embodiment shown in FIG. 44 acquires and transfers characteristic information possessed by a user when data of a range specified area is transferred to a transfer destination. FIG. 44 shows data format 55 that is transferred to a transfer destination. A verification code is located in front of the data of the range specified area. For example, in the case the transfer destination to which data of a range specified area is transferred is a search engine under WWW membership, characteristic user information in the form of an identification code is read from hard disk 21 and transferred to the search engine along with a search keyword in the form of data of the range specified area in order to control the session and verify the user. This is one example of an effective application of this embodiment.

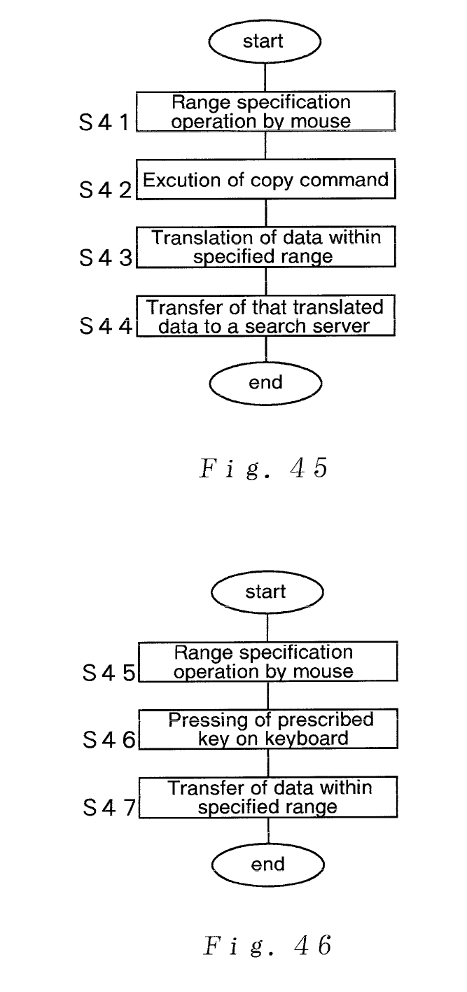

The next embodiment transfers a keyword of a specified range to a transfer destination after translating it. This is explained using the flow chart of FIG. 45. After performing a range specification operation using a mouse by a user (Step S41), when the mouse pointer is placed within a range specified area and a clicking operation is performed, data of the range specified area is copied to a clipboard. Namely, a copy command is executed (Step S42). The clipboard is constantly monitored, and if its contents are rewritten by the data of the range specified area, the data transfer program translates this data by applying a translation function (Step S43) and then transfers that result to a search server (Step S44).

Namely, in this embodiment, prior to processing for transferring data of a range specified area to a transfer destination, the data in this range specified area is subjected to processing for translating to a different language. Thus, data specified by a range specification operation using an input device from a page written in the native language of the user can be translated into a different language and then transferred to a document editor. In addition, if, for example, data is transferred to a search destination after translating into a different language, pages in that different language can be gathered into a link collection for the search result. Following this, the result should be translated back into the native language of the user as necessary. Furthermore, the type of language may be able to be selected prior to translating the data in the range specified area into a different language.

Next, in the present invention, transferring data within a range specified area to a transfer destination by pressing a switch equipped with an input device different from the input device used for the range specification operation after data is specified by a range specification operation using an input device is within the scope of claim for patent of the present invention. For example, in the case of processing in which, when a range specification operation has been performed by an operation combining the arrow keys and Shift key of a keyboard, data of a range specified area is transferred once the focus is placed on the range specified area and the Enter key has been pressed, the same input device, namely the keyboard, is used for both the range specification operation and the transfer operation. In contrast, processing in which, for example, data is transferred once the Enter key of a keyboard has been pressed after performing a range specification operation by a mouse, is equivalent to the present invention.

This embodiment is shown with the flow chart of FIG. 46. Once a range specified area has been performed with mouse 1 and the focused has been placed there (Step S45), and a prescribed key on the keyboard has been pressed (Step S46), data of the range specified area where the focus is placed is transferred to a transfer destination (Step S47).

Next, the receiving of the results of voice recognition of words vocalized by a user to the effect that a range is desired to be specified, and focusing on a displayed line of text in the case a judgment is made that the line of text of the recognition results agrees with the displayed line of text is also within the scope of claim for patent of the present invention.

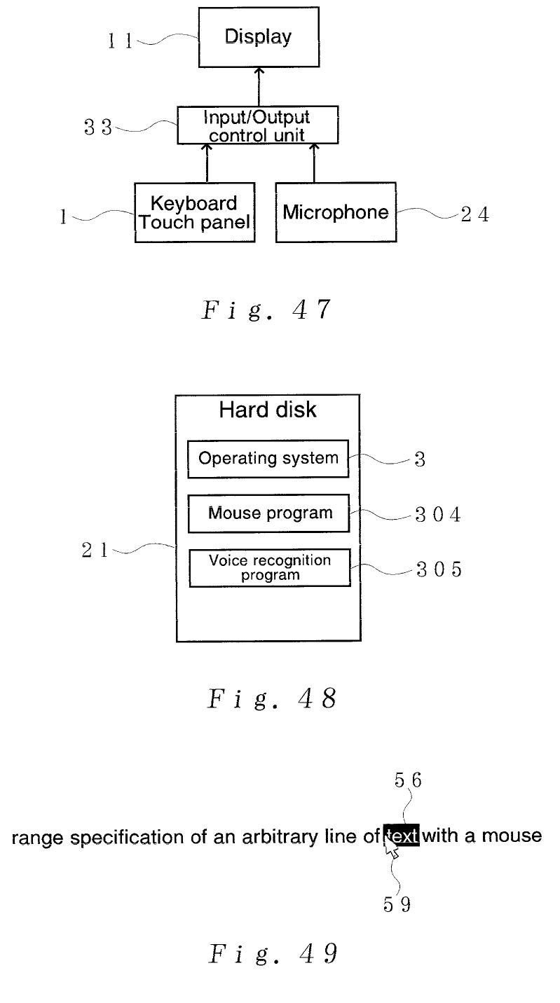

FIGS. 47 through 50 show an embodiment in which, in the case a user verbalizes a line of text to the effect that a range is desired to be specified, those words are received, voice recognition is performed and a judgment is made to determine whether the voice-recognized line of text agrees with the line of text desiring range specification, after which, in the case they are found to agree, the line of text of the range specified area is transferred to a transfer destination by pressing the Enter key on a keyboard.

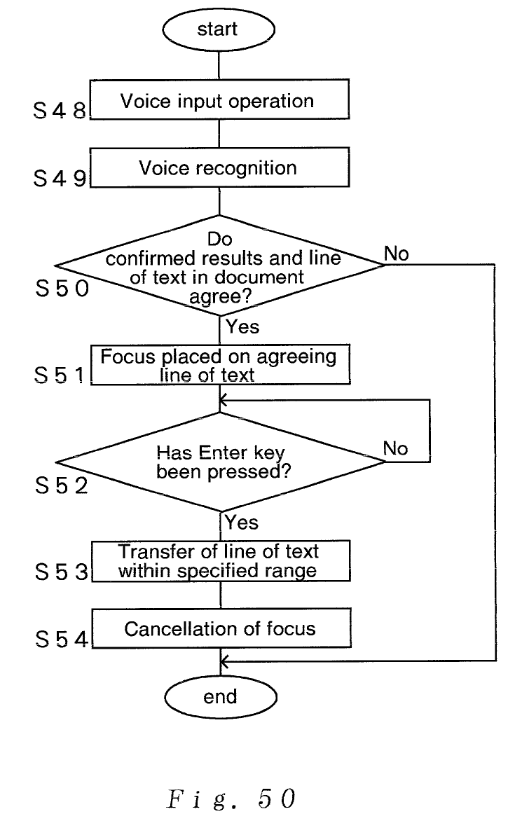

Microphone 24, keyboard and touch panel 1, and display 11 are connected to input/output control unit 33. Voice recognition program 305 is installed in hard disk 21 along with mouse program 304. Voice picked up by microphone 24 is transferred to voice recognition program 305 by input/output control unit 33 where voice recognition processing is performed. A flow chart relating to this processing is shown in FIG. 50.

A voice input operation is performed by an operator towards microphone 24 (Step S48). In this case, the operator views a document displayed on display 11 and vocalizes in words the line of text contained in that document for which the range is desired to be specified. In Step S49, this voice recognition is performed and in Step S50, a judgment is made as to whether the result of this recognition agrees with the line of text for which the range is desired to be specified in the document agree. Processing is terminated if they do not agree. In the case they do agree, the focus is placed on the agreeing line of text in the document (agreement range 56) and that line of text is highlighted (Step 51). As shown in FIG. 49, this state can be more easily understood by considering pointer 59 of touch panel 1 to be within a range specified area. Therefore, when the Enter key on the keyboard is pressed (Step S52), the line of text of the range specified area is transferred to a transfer destination (Step S53), and the above focus is canceled (Step S54). Furthermore, the entire document is searched in Step S50. Thus, dictionary searches, WWW searches and so forth can be performed without performing a manual range specification operation.

Furthermore, although a program can be designed so as to transfer a line of text to a transfer destination by touching agreement range 56 of touch panel 1 with the finger instead of having an operator press the Enter key on a keyboard, if this is not preferred due to the surface of touch panel 1 becoming soiled with oil from the skin, a push-button switch or other dedicated switch may be provided instead.

In addition, in Step S51, the focus is placed on agreement range 56 followed by highlighting. Although a highlighted or other type of emphasized display is not essential, emphasized display of vocalized words is intuitively easily understood.

However, related references can also be accessed from data of a specified range by the above audio input and pressing of the Enter key on a keyboard by transferring a line of text even for those areas on a page not provided with a link, and this may be performed without operating a mouse and so forth. This being the case, good operability would be able to be obtained if it was possible to jump between links using the arrow keys of a keyboard for links on a WWW page, and obtain the same effects as a system in which a link is clicked by pressing an Enter key.

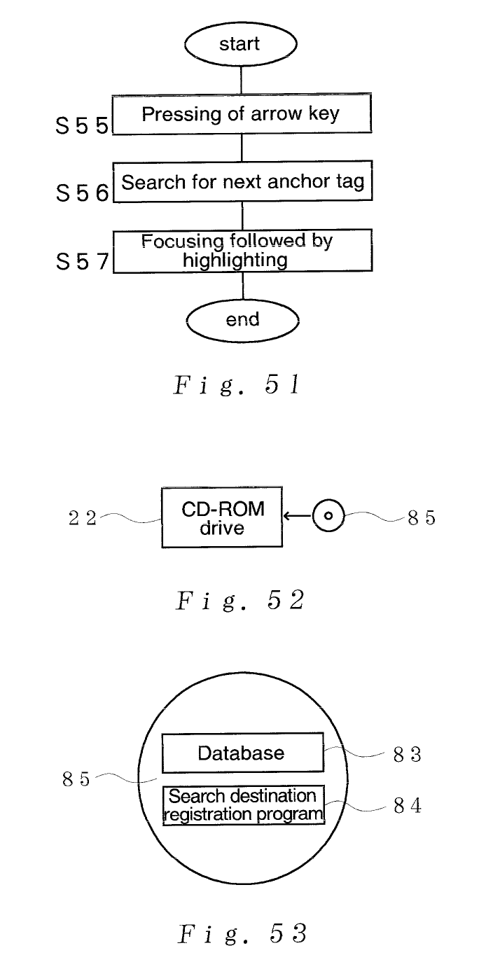

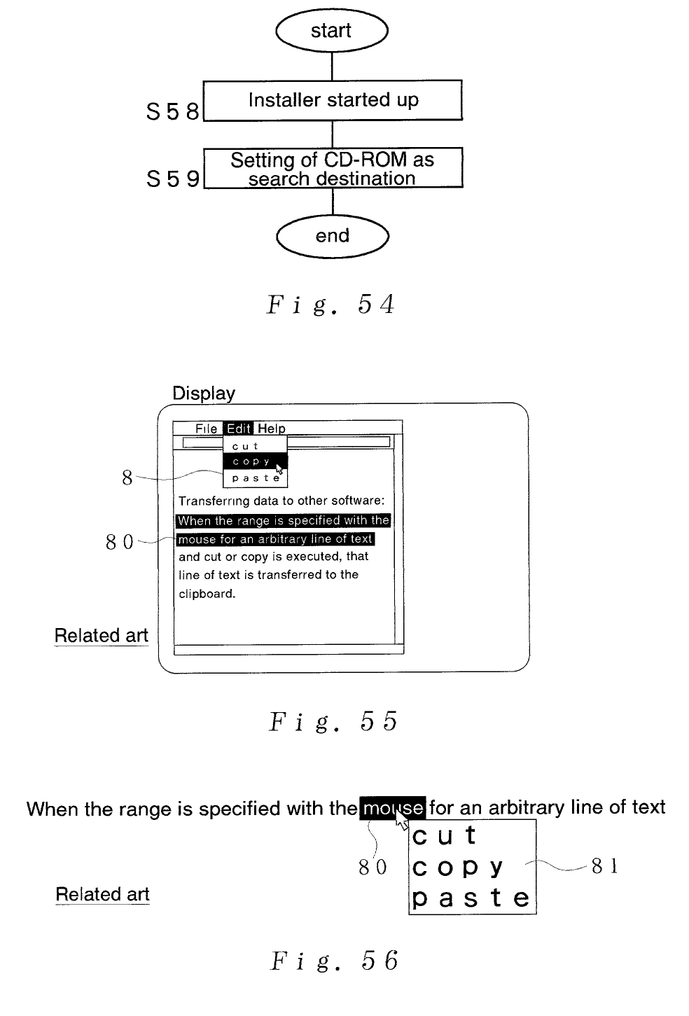

FIG. 51 shows an example of this embodiment. Although the sound range specification procedure is the same as that described above, once an arrow key is additionally pressed (Step S55), and the next anchor tag is found in the direction indicated by the arrow key (Step S56), the focus is placed on the link and the display is highlighted (Step S57).

Thus, together with being able to specify a desired link by successively transferring between links with arrow keys, range specification operations and data transfer can be performed by voice input for the entire WWW page including the link, thereby resulting in a significant improvement in operability. Furthermore, this operating method of jumping between links can also be applied to other input methods other than voice input.

Next, the following provides an explanation of a method of registering transfer destinations later using FIGS. 52 through 54. Database 83 and search destination registration program 84 are recorded on CD-ROM 85. This CD-ROM 85 is inherently different from CD-ROM 23 shown in FIG. 30 in that it does not contain that composing the main element of the present invention. Database 83 is used either by installing on hard disk 21 or used directly by inserting CD-ROM 85 into CD-ROM drive 22. When the Installer of search destination registration program 84 is started up (Step S58), database 83 sets itself as the search destination (Step S59).

Examples of applications of this include encyclopedias and various other types of dictionary software, textbooks and article databases contained on CD-ROM, DVD-ROM and so forth. Regardless of the page, simply by generating a keyword with a range specification operation and performing a switching operation on that range, search results can be obtained quickly by the search method of the present invention.

Furthermore, the present invention is not limited to the embodiments described above. For example, when a range specified area is treated as an object, and a switching operation is performed by an input device on that object, the present invention can be designed to transfer data of a range specified area to a transfer destination. This should use, for example, an onClick event provided by Internet Explorer and so forth that operates with Windows (trade mark of the Microsoft Corp.) that is a typical GUI operating system. Data obtained with the range specification operation and data obtained with the onClick event on this range specified area are compared and if both are identical, this data is transferred to a transfer destination. Thus, the present invention can be provided easily.

Although a specified range is typically highlighted with respect to lines of text, this can be set arbitrarily such as to color highlighting, changing of character color, blinking character display, changing to italic characters, bold characters or bordered characters or underlining. In addition, the specified range can also be made to not be particularly conspicuous. With respect to the display of the transfer destination menu, the transfer destination that is used most frequently on the menu may be made to be arranged at the top of the menu by referring to transfer history. Alternatively, the program may also be set so that a pointer automatically moves to the most frequently used transfer destination without rearranging the menu. An editing box may also be made to be displayed that enables editing of range-specified data. A menu may also be displayed for selecting and executing a transfer destination once a mouseUp event occurs at the end of the range specification operation. In addition, the present invention can be realized with that equipped with an OS as the basic functions, a mouse driver, an application program or plug-in software incorporated into an application program, and there are no particular restrictions on such.

According to the present invention as described above, data can be transferred to a transfer destination simply by generating data to be transferred at any area on an arbitrary page, and performing a switching operation on that area. This operation has previously not been considered at all and offers extremely good operability. Moreover, the present invention can be utilized in a wide range of applications other than those described in the embodiments, and the effect of the present invention on future information technology is extremely significant.

What is claimed is:

1. A data transfer method comprising: displaying an operation target arbitrarily selected by a user, judging whether coordinates when a switching operation was performed by an input device for said operation target are within a range specified with a range specification operation by an input device prior to this switching operation, and transferring data within said specified range to a transfer destination in the case said coordinates are within the specified range.

2. A data transfer method according to claim 1 wherein, a first switch is used for the switching operation of the input device.

3. A data transfer method according to claim 1 wherein, range specification is performed according to predetermined rules when a switching operation is performed at an arbitrary location where a range is desired to be specified.

4. A data transfer method according to claim 1 wherein, range division is performed in advance according to predetermined rules for an operation target of an input device, and if an arbitrary divided range among a plurality of divided ranges is instructed by an input device, that divided range is used as the specified range.

5. A data transfer method according to claim 1 wherein, an arbitrary transfer destination among a plurality of transfer destinations can be set for the transfer destination.

6. A data transfer method according to claim 1 wherein, together with displaying a plurality of transfer destinations on a menu and selecting a transfer destination from that menu, the most recently selected transfer destination is used as the default transfer destination.

7. A data transfer method according to claim 1 wherein, in the case the operation target has a hyper link, processing can be performed to disable that hyper link.

8. A data transfer method according to claim 1 wherein, the pointer of an input device is moved to within a specified range after specifying that range.

9. A data transfer method according to claim 1 wherein, data within a specified range is transferred to a transfer destination by designating data by a range specification operation using an input device, followed by pressing a switch provided by a different input device than the input device used to perform the range specification operation.

10. A data transfer method according to claim 1 wherein, control is performed by receiving the results of voice recognition of words vocalized by a user indicating the desire to specify a range, judging whether the line of text of the recognition results agrees with a displayed line of text, and placing the focus on the displayed line of text if they agree.

11. A data transfer device equipped with:
an input device,
a display device for displaying an operation target arbitrarily selected by a user and which is operated using the input device, and,
a processing device that judges whether coordinates when a switching operation was performed by said input device for said operation target are within a range specified with a range specification operation performed prior to this switching operation by said input device, and transfers data within said specified range to a transfer destination based on transfer destination data in the case said coordinates are judged to be within said specified range.

12. A data transfer device according to claim 11 wherein, a first switch is used for the switching operation of the input device.

13. A data transfer device according to claim 11 wherein, said processing device performs range specification according to predetermined rules when a switching operation is performed at an arbitrary location where the range is desired to be specified.

14. A data transfer device according to claim 11 wherein, range division is performed in advance according to predetermined rules for an operation target of an input device, and if an arbitrary divided range among a plurality of divided ranges is instructed by an input device, said processing device uses that divided range as the specified range.

15. A data transfer device according to claim 11 wherein, said processing device makes it possible to set an arbitrary transfer destination among a plurality of transfer destinations for the transfer destination.

16. A data transfer device according to claim 11 wherein, said processing device makes it possible to display a plurality of transfer destinations on a menu and select a transfer destination from that menu, while also making it possible to use the most recently selected transfer destination as the default transfer destination.

17. A data transfer device according to claim 11 wherein, said processing device is able to perform processing that disables the operation of a hyper link in the case said operation target has a hyper link.

18. A data transfer device according to claim 11 wherein, said processing device makes it possible to move the pointer of an input device to within a specified range after specifying that range.

19. A data transfer device according to claim 11 wherein, said processing device transfers data within a specified range to a transfer destination by designating data by a range specification operation using an input device, followed by pressing a switch provided by a different input device than the input device used to perform the range specification operation.

20. A data transfer device according to claim 11 wherein, said processing device performs control by receiving the results of voice recognition of words vocalized by a user indicating the desire to specify a range, judging whether the line of text of the recognition results agrees with a displayed line of text, and placing the focus on the displayed line of text if they agree.
